(19) United States
(12) Patent Application Publication
(10) Pub. No.: US 2016/0071322 A1
(43) Pub. Date: Mar. 10, 2016

(54) IMAGE PROCESSING APPARATUS, IMAGE PROCESSING SYSTEM AND STORAGE MEDIUM

(71) Applicant: KABUSHIKI KAISHA TOSHIBA, Tokyo (JP)

(72) Inventors: Masashi NISHIYAMA, Kawasaki (JP); Masahiro SEKINE, Tokyo (JP); Kaoru SUGITA, Tokyo (JP)

(21) Appl. No.: 14/826,341

(22) Filed: Aug. 14, 2015

(30) Foreign Application Priority Data
Sep. 4, 2014 (JP) 2014-180269

(51) Int. Cl. G06T 19/00; G06T 3/00

(52) U.S. Cl. CPC G06T 19/006; G06T 3/0006; G06T 2210/16

(57) ABSTRACT

According to one embodiment, an image processing apparatus includes a storage, an acquisition module, a first calculator, a second calculator, a selection module and a generator. The storage is configured to store clothing images corresponding to rotational angles. The acquisition module is configured to acquire a subject image. The first calculator is configured to calculate a first rotational angle based on the subject image. The second calculator is configured to calculate a second rotational angle based on the first rotational angle. The selection module is configured to select a clothing image corresponding to the second rotational angle. The generator is configured to generate a composite image based on the clothing image and the subject image.

### CROSS-REFERENCE TO RELATED APPLICATIONS

This application is based upon and claims the benefit of priority from Japanese Patent Application No. 2014-180269, filed Sep. 4, 2014, the entire contents of which are incorporated herein by reference.

### FIELD

Embodiments described herein relate generally to an image processing apparatus, an image processing system and a storage medium.

### BACKGROUND

Recently, a technique that enables a user to, for example, virtually do a trial fitting of clothing (hereinafter, referred to as a virtual trial fitting) has been developed.

Since in this technique, for example, a composite image obtained by superimposing a clothing image upon an image including a user (subject) imaged by an imaging module can be displayed on a display that opposes the user, the user can select preferable clothing without an actual trial fitting.

Further, in this technique, even when the user rotates the body with respect to the above-mentioned imaging module, a composite image obtained by superimposing an image of clothing that fits the body can be displayed.

It should be noted that, in order to ascertain an overall mood of clothing, the user may want to check, for example, their back sight.

However, when checking the back sight during virtual trial fitting, the user has to greatly rotate their body with respect to the above-mentioned imaging module, which is troublesome.

Moreover, when rotating the body to check the clothing (image) at a desired angle, the user has to adjust the rotation (angle) of the body so that the clothing is displayed at the desired angle, which is also troublesome.

### BRIEF DESCRIPTION OF THE DRAWINGS

FIG. 1 is a perspective view showing an example of external appearance of an image processing system;

FIG. 2 is a view showing another example of external appearance of the image processing system;

FIG. 3 is a block diagram mainly showing an example of the functionality configuration of an image processing apparatus;

FIG. 4 is a view showing an example of a data structure of first data;

FIG. 5 is a schematic diagram showing a specific example of the first data;

FIG. 6 is a view showing an example of a data structure of second data;

FIG. 7 is a view showing an example of a data structure of third data;

FIG. 8 shows an example of three dimensional model data of a human body;

FIG. 9 shows an example of a model image obtained by applying the three dimensional model data to a depth image of a first subject;

FIG. 10 is a view for explaining an example of calculation of posture data;

FIG. 11 is a view for explaining an example of an operation for selecting a clothing image;

FIG. 12 is a view conceptually showing an example of the posture data;

FIG. 13 is a view for explaining an example of calculation of the size of a feature area;

FIG. 14 is a view for explaining another example of the calculation of the size of a feature area;

FIG. 15 is a view for explaining an example of outline extraction;

FIG. 16 is a view for explaining an example of calculation of a second position;

FIG. 17 is a view for explaining an example of registration and update of the first data;

FIG. 18 is a flowchart showing an example of the processing procedure of the image processing apparatus;

FIG. 19 is a flowchart showing an example of the procedure of first clothing-image selection processing;

FIG. 20 is a flowchart showing an example of the procedure of first-position calculation processing;

FIG. 21 is a flowchart showing an example of the procedure of second-position calculation processing;

FIG. 22 is a view for explaining an example of generation of a composite image;

FIG. 23 is a view showing an example of a composite image;

FIG. 24 is a flowchart showing an example the procedure of second clothing-image selection processing in a case where a following mode is set;

FIG. 25 is a flowchart showing an example the procedure of second clothing-image selection processing in a case where a full-length-mirror mode is set;

FIG. 26 is a view showing an example of a composite image presented in the case where the following mode is set;

FIG. 27 is a view showing an example of a correspondence relationship between the rotational angle of a first subject and that of displayed clothing in the case where the following mode is set;

FIG. 28 is a view showing an example of a composite image presented in the case where the full-length-mirror mode is set;

FIG. 29 is a view showing an example of the correspondence relationship between the rotational angle of the first subject and that of displayed clothing in the case where the full-length-mirror mode is set;

FIG. 30 is a view showing another example of the correspondence relationship between the rotational angle of the first subject and that of displayed clothing in the case where the full-length-mirror mode is set;

FIG. 31 is a view showing yet another example of the correspondence relationship between the rotational angle of the first subject and that of displayed clothing in the case where the full-length-mirror mode is set;

FIG. 32 is a schematic view for explaining an example of a system configuration of the image processing system; and

FIG. 33 is a view showing an example of a hardware configuration of the image processing apparatus.

### DETAILED DESCRIPTION

Various embodiments will be described with reference to the accompanying drawings.

In general, according to one embodiment, an image processing apparatus includes a storage, an acquisition module, a first calculator, a second calculator, a selection module and a generator. The storage is configured to store clothing images corresponding to respective rotational angles of a subject with respect to an imaging module. The acquisition module is configured to acquire a first subject image including the subject imaged by the imaging module. The first calculator is configured to calculate a first rotational angle of the subject in the first subject image. The second calculator is configured to calculate a second rotational angle different from the first rotational angle, based on the first rotational angle. The selection module is configured to select a clothing image corresponding to the second rotational angle of the clothing images. The generator is configured to generate a composite image by superposing the clothing image upon the first subject image.

FIG. 1 shows an example of external appearance of an image processing system including an image processing apparatus according to an embodiment. The image processing system 10 of FIG. 1 including a housing 11, a display module 12, a weight measuring module 13, an input module 14 and an imaging module. The image processing apparatus of the embodiment is omitted in FIG. 1, although it is included in the housing 11.

As shown in FIG. 1, the housing 11 of the image processing system 10 has a rectangular shape, and the display module 12 is included in one surface of the housing 11. The display module 12 includes a display device like a liquid crystal display, and is configured to display various images, for example.

In the image processing system 10, a composite image W showing a state where a subject (hereinafter, referred to as a first subject) P tries on each type of clothing is displayed on the display module 12. The image processing system 10 may further include a printer for printing the composite image W, or a transmitter for transmitting the composite image W to an external device through a network.

Here, the first subject P is a target which tries on clothing. It is sufficient if the first subject P is a target which tries on clothing. The first subject P may be a living being or a non-living matter. If the first subject P is a living being, it may be, for example, a person. However, the first subject P is not restricted to a person, but may be a pet, such as a dog or a cat. If the first subject P is a non-living being, it may be a mannequin having a form of a human body or a pet, or may be clothing and other things. Still, the first subject P is not restricted to them. The first subject P may further be a clothed living being or clothed non-living matter.

Moreover, clothing includes articles (goods) that the first subject P can wear. The clothing includes a coat, a skirt, trousers, shoes, a hat, etc. In addition, the clothing is not limited to a coat, a skirt board, trousers, shoes, a hat, etc.

The first subject P can see the composite image W presented (displayed) on the display module 12, from, for example, a position opposing the display module 12.

The weight measuring module 13 is provided on the bottom of a region opposing the display module 12. When the first subject P is in the position opposing the display module 12, the weight measuring module 13 measures the weight of the first subject P.

The input module 14 inputs (accepts) a variety of data in accordance with a user's operation instruction. The input module 14 is formed of one or more of a mouse, a button, a remote controller, a keyboard, voice recognition equipment such as a microphone, and image recognition equipment. The user in the embodiment is a general term for an operator, like the first subject, for operating the image processing system 10.

FIG. 1 shows an example of a case where image recognition equipment is employed as the input module 14. In this case, each gesture, for example, of the user opposing the input module 14 can be accepted as a user's instruction. At this time, the image recognition equipment accepts the user's instruction by pre-storing instruction data corresponding to each gesture, and reading instruction data corresponding to a recognized gesture. The input module 14 may be a communication device that accepts a signal indicative of a user's operation instruction from an external device, such as a portable terminal, for transmitting various data items. In this case, the input module 14 accepts the signal, indicative of the operation instruction, received from the external device.

Moreover, although the display module 12 and the input module 14 are separately provided in FIG. 1, they may be formed integral as one body. More specifically, the display module 12 and the input module 14 may be constituted as a user interface (UI) module having both an input function and a display function. A liquid crystal display (LCD) with a touch panel, for example, is included in the UI module.

An imaging module includes first imaging module 15A and second imaging module 15B. First imaging module 15A continuously images the first subject P at regular intervals, thereby sequentially acquiring subject images including the imaged first subject P (hereinafter, referred to as subject images of the first subject P). Each subject image is a bitmapped image, and is an image in which a pixel value indicating the color, brightness, etc., of the first subject P is defined for each pixel. As first imaging module 15A, an imaging device (camera) capable of acquiring subject images is used.

Second imaging module 15B continuously images the first subject P at regular intervals, thereby sequentially acquiring depth images including the imaged first subject P (hereinafter, referred to as depth images of the first subject P). The depth image is also called a range image, and defines the distance from second imaging module 15B pixel by pixel. As second imaging module 15B, an imaging device (depth sensor) capable of acquiring depth images is used.

In the embodiment, first imaging module 15A and second imaging 15B image the first subject P simultaneously. That is, first imaging module 15A and second imaging module 15B are controlled by, for example, a controller (not shown), to sequentially image the first subject P in synchronism with each other. As a result, first imaging module 15A and second imaging module 15B acquire (a combination of) a subject image and a depth image of the first subject P imaged (acquired) simultaneously. The simultaneously acquired subject image and depth image of the first subject P are outputted to an image processing apparatus described later.

The above-mentioned input module 14 and imaging module (first imaging module 15A and second imaging module 15B) are supported by the housing 11 as shown in FIG. 1. The input module 14 and first imaging module 15A are provided near the horizontal opposite ends of the display module 12 in the housing 11. Second imaging module 15B is provided near the upper part of the display module 12 in the housing 11. However, the installation position of the input module 14 is not limited to the mentioned position. Further, it is sufficient if first imaging module 15A and second imaging module 15B are provided in postures in which they can image the first subject P, and their positions are not limited to those shown in FIG. 1.

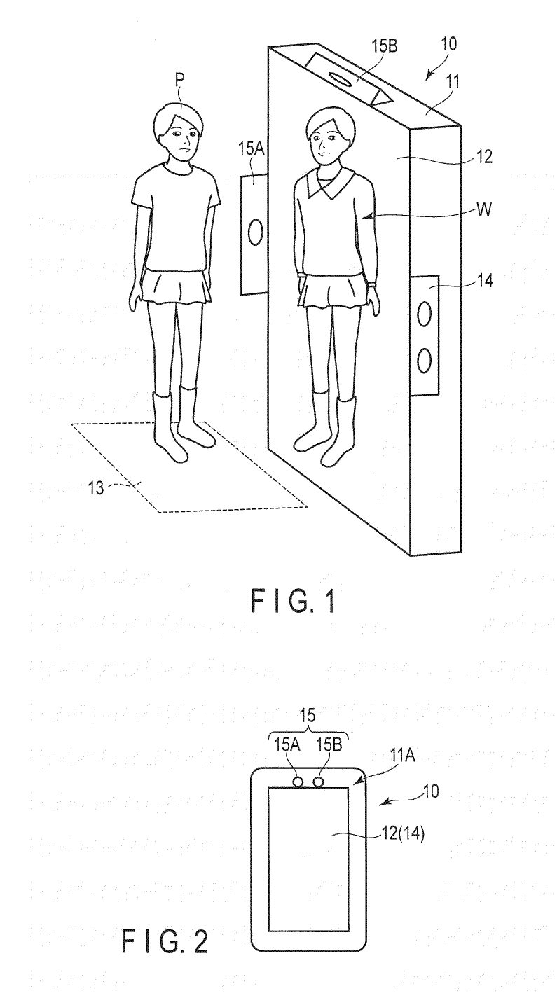

The image processing system 10 may be realized as a mobile terminal as shown in FIG. 2. In this case, housing 11A of the image processing apparatus as the mobile terminal is provided with the UI module having both the functions of the display module 12 and the input module 14, first imaging module 15A, and second imaging module 15B. Further, the image processing apparatus according to the embodiment is provided in housing 11A.

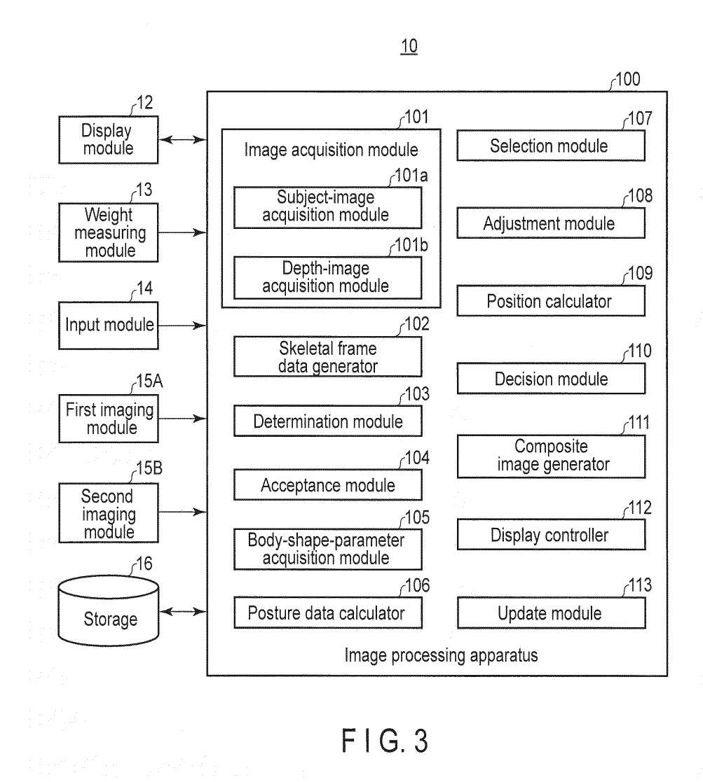

FIG. 3 is a block diagram mainly showing the functionality configuration of an image processing apparatus according to the embodiment. As shown in FIG. 3, the image processing apparatus 100 is connected to the display module 12, the weight measuring module 13, the input module 14, first imaging module 15A, second imaging module 15B, and a storage 16 so that it can communicate with them. In FIG. 3, the display module 12, the weight measuring module 13, the input module 14, the imaging module (first imaging module 15A and second imaging module 15B) and the storage 16 are provided separately from the image processing apparatus 100. However, at least one of them may be formed integral with the image processing apparatus 100.

Since the display module 12, the weight measuring module 13, the input module 14, first imaging module 15A, and second imaging module 15B are already described with reference to FIG. 1, they will not further be described in detail.

The storage 16 stores various types of data. More specifically, the storage 16 pre-stores first data, second data, third data and fourth data. The first data to the fourth data will be described first.

The first data includes a plurality of clothing sizes, a plurality of body-shape parameters corresponding to the respective clothing sizes and indicating different body shapes, and a plurality of clothing images indicating states where subjects (hereinafter, referred to as “second subjects”) of body shapes indicated by the body-shape parameters corresponding to the clothing sizes wear clothing items of the clothing sizes, for each identification data (hereinafter, referred to as “clothing ID”) to identify clothing. The respective clothing sizes, body-shape parameters and clothing images are arranged in the first data in association with each other.

The second subject is a subject that was wearing clothing when a clothing image included in the first data was acquired (namely, when the clothing image was picked up). It is sufficient if the second subject is a dressed subject. Namely, the second subject may be a living being like the above-mentioned first subject, or may be a non-living matter, such as a mannequin formed like a human body.

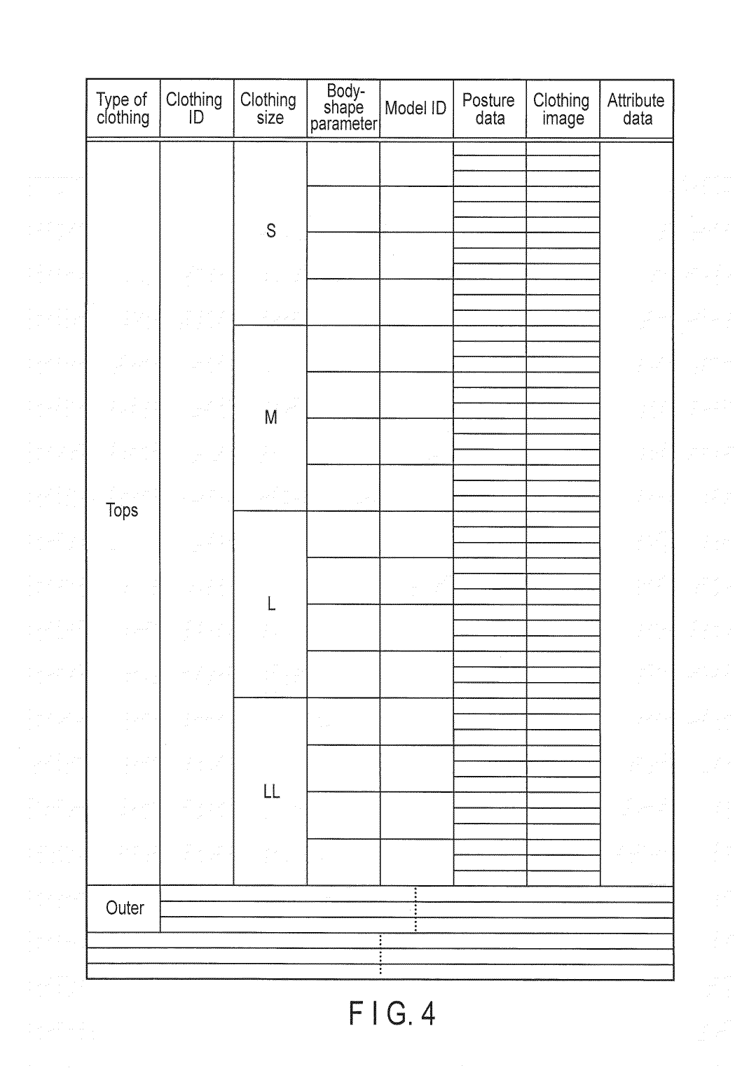

FIG. 4 shows an example of a data structure of the first data stored in the storage 16. In the example shown in FIG. 4, the first data includes clothing types, clothing IDs, clothing sizes, body-shape parameters, model IDs, posture data, clothing images, attribute data, which are arranged in association with each other.

The clothing type indicates each type obtained when clothing is classified into a plurality of types under predetermined classification conditions. The clothing type includes tops, outer, bottom, etc. However, the clothing type is not limited to them.

The clothing ID is data for identifying clothing, as mentioned above. Specifically, clothing indicates ready-made one. Although the clothing ID includes, for example, a product number and the name of clothing. However, the clothing ID is not limited to them. As the product number, a JAN code system, for example, can be used. Further, as the name, an article name of clothing, for example, can be used.

The clothing size is data indicating the size of clothing. The clothing size includes, for example, S, M, L, LL or XL as a ready-made clothing size. However, the clothing size is not limited to them. The clothing size differs in notation among, for example, countries in which clothing is produced or sold.

The body-shape parameter is data indicating the body shape of the second subject. The body-shape parameter includes one or more parameters. This parameter is associated with, for example, one or more measurement values or weight, the measurement values being values corresponding to one or more portions of a human body measured, for example, when clothing is made or purchased. More specifically, it is assumed that the body-shape parameter includes at least one of parameters corresponding to a chest measurement, a waist measurement, a hip measurement, a height, a shoulder measurement and a weight. However, the parameters included in the body-shape parameter are not limited to them. The body-shape parameter may also include parameters indicating a sleeve length, a leg length, etc. Further, measurement values as parameters are not limited to actually measured values, but also include estimated measurement values and values (including values arbitrarily input by the user) equivalent to the measurement values.

Users of the same or substantially the same body shape may put on clothes of different sizes S, M, L and/or LL. In other words, the size of clothing worn by a user of a certain body shape is not limited to one, and the user may wear clothing of different sizes, depending upon their tastes, the type of clothing, etc.

For this reason, in the first data of the embodiment, a plurality of body-shape parameters indicating different body shapes are associated with one clothing size of one clothing ID.

The model ID is identification data for identifying the second subject of a body shape corresponding to a body-shape parameter.

The clothing image is an image in which a pixel value indicating the color, brightness, etc., is defined for each pixel. The first data includes clothing images corresponding to respective body-shape parameters. Namely, the first data associates a plurality of body-shape parameters indicating different body shapes with one clothing size of one clothing ID, and associates clothing images with the respective body-shape parameters.

The clothing images are images indicating states in which second subjects of body-shape parameters corresponding to a clothing size in the first data parameter wear clothing of the clothing size. Namely, clothing images, which correspond to a plurality of body-shape parameters indicating different body shapes corresponding to one clothing size, indicate respective states in which a plurality of second subjects of different body shapes wear clothing of the same clothing size.

The posture data indicates the posture of a second subject when a clothing image has been acquired. The posture data indicates the orientation, movement, etc., of the second subject with respect to the above-described imaging module.

The orientation of the second subject means an orientation of the second subject wearing clothing corresponding to a clothing image when the clothing image has been acquired, with respect to the imaging module. The orientation of the second subject includes, for example, an orientation of the second subject when its face and body are facing the front with respect to the imaging module, an orientation of the second subject when its face and body are facing the left or right with respect to the imaging module, an orientation other than them, etc. Namely, the orientation of the second subject is indicated by the angle (namely, the rotational angle) of the body of the second subject with respect to the imaging module.

The movement of the second subject is indicated by skeletal frame data that indicates the position of the skeletal frame of the second subject wearing the clothing of a clothing image. The skeletal frame data defines pixel locations corresponding to the positions of the skeletal frame of the second subject wearing the clothing corresponding to the clothing image, in the clothing image. In the embodiment, the posture data includes the orientation of the second subject and the skeletal frame data.

Moreover, in the embodiment, the first data includes a plurality of clothing images corresponding to different posture data items (that is, the rotational angles), as clothing images corresponding to a plurality of body-shape parameters.

That is, in the embodiment, a clothing image is an image that indicates a state in which a second subject of a body shape specified by a body-shape parameter wears clothing of a certain size, and corresponds to the posture of the second subject when the second subject was imaged.

The attribute data indicates the attribute of clothing identified by corresponding clothing ID. The attribute data includes, for example, the name of clothing, the distribution source (for example, a brand name) of clothing, the form of clothing, the color of clothing, the raw material of clothing, the price of clothing, etc.

In addition, it is sufficient if the first data at least includes, for example, the clothing ID, the clothing size, the body-shape parameter, the posture data, and the clothing image in association with each other. Namely, the first data does not have to include at least the data indicating the type of clothing, the model ID, or the attribute data.

Moreover, the first data may further include data for suggesting how to wear clothing (a way of wearing with buttons fastened, a way of wearing with buttons unfastened, etc.). In this case, in the first data, it is sufficient if a plurality of clothing images corresponding to various ways of wearing are associated with one posture data item.

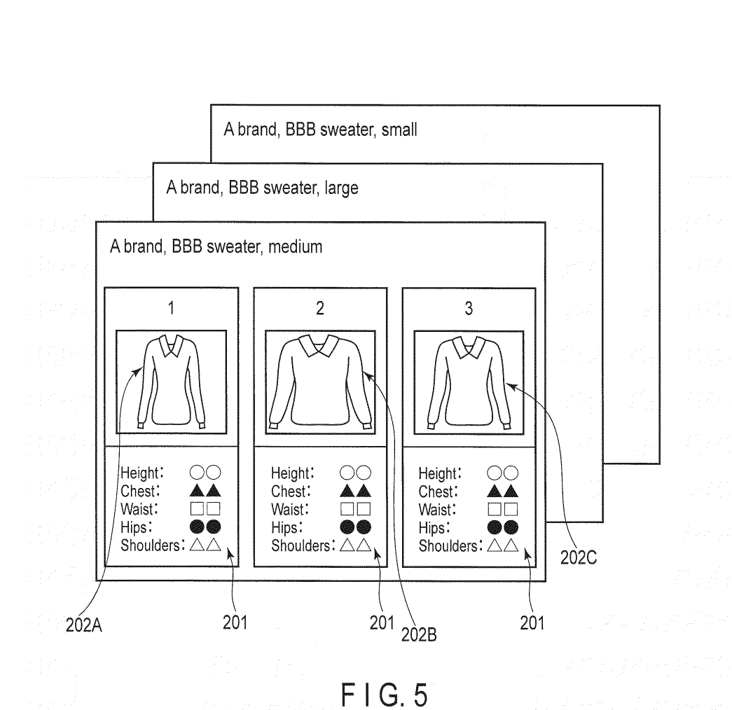

FIG. 5 is a schematic view showing the first data specifically. As shown in FIG. 5, the first data includes clothing images corresponding to respective body-shape parameters 201. That is, the first data associates a plurality of body-shape parameters 201, indicating different body shapes, with each of clothing sizes (M clothing size, L clothing size, S clothing size) of clothing identified by one clothing ID (for example, an A brand, a BBB sweater). Further, the first data associates clothing images (in this example, clothing images 202A to 202C) with the respective body-shape parameters 201. In the example shown in FIG. 5, each body-shape parameter includes, as parameter components, a height, a chest measurement, a waist measurement, a hip measurement and a shoulder measurement.

Namely, clothing images 202A to 202C are images that indicate states in which a plurality of second subjects of different body shapes wear the same clothing of the same size (in FIG. 5, the BBB sweater of the A brand and the M size).

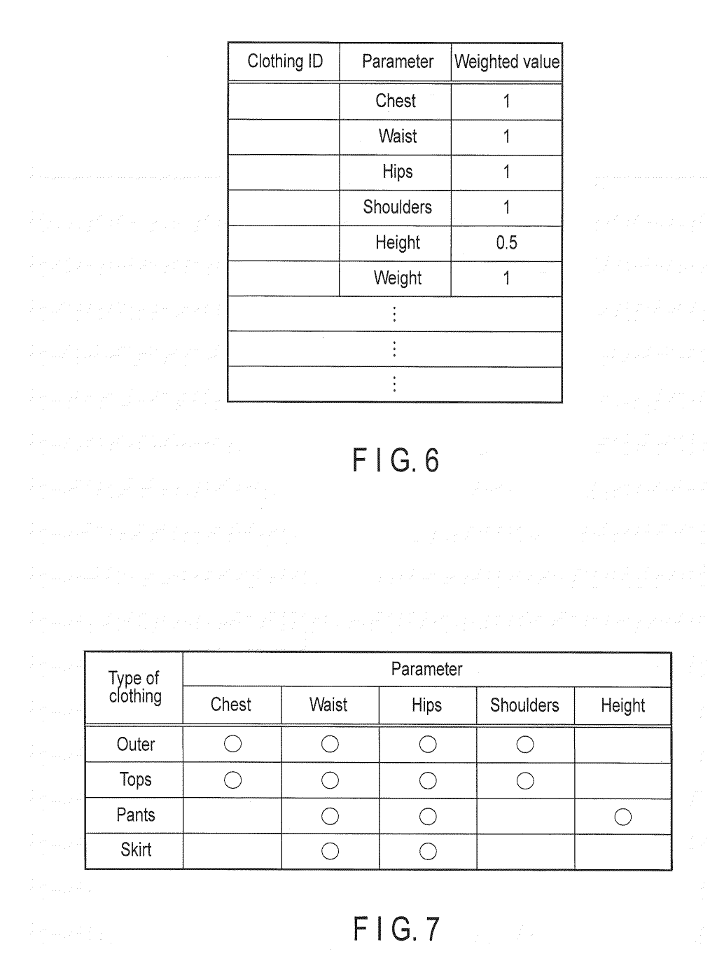

FIG. 6 shows an example of a data structure of the second data stored in the storage 16. The second data includes clothing IDs, parameter components indicating each body shape, and weighted values that are arranged in association with each other. The parameter components indicating each body shape are similar to those included in a corresponding body-shape parameter in the first data. The weighted values indicate the degrees of influence of parameter components upon differences in vision when clothing items identified by corresponding clothing ID are worn. The lower the weighted value, the smaller the degree of influence of the parameter component upon the difference in vision when clothing is worn. In contrast, the higher the weighted value, the greater the degree of influence of the parameter component upon the difference in vision when clothing is worn. The weighted value is used for calculation of the degree of dissimilarity described later. In the second data, the type of clothing may be further associated.

For example, assume that the degree of influence of parameter components other than the height upon the difference in vision when the clothing identified by certain clothing ID is worn is higher than that of the height. In this case, the image processing apparatus 100 sets second data including weighted-parameter data corresponding to the clothing ID, in which the weighted value of the height is set lower than that of the other parameter components, as is shown in FIG. 6.

Moreover, if the type of clothing corresponding to the clothing ID is, for example, “tops,” a parameter corresponding to the lower half side of a human body has a lower degree of influence upon the difference in vision when the clothing is worn. In this case, the image processing apparatus 100 sets second data including weighted-parameter data corresponding to the clothing ID associated with the clothing type “tops,” in which the weighted values of the hip measurement and the height are set lower than that of the other parameter components.

The respective weighted values corresponding to the parameters of the clothing IDs can be appropriately changed by, for example, a user instruction through the input module 14. It is sufficient if the user inputs parameter weighted values in advance for clothing identified by each clothing ID, thereby registering them in the second data.

FIG. 7 shows an example of a data structure of the third data stored in the storage 16. The third data includes clothing types and parameter components arranged in association with each other, the parameter components being used for calculation of degrees of dissimilarity. The third data may be data that associates parameter components for calculation of degrees of dissimilarity with each clothing ID. Moreover, the third data may include data that associates parameter components used for calculation of the degree of dissimilarity for each clothing image. Calculation of the degree of dissimilarity will be described later.

FIG. 7 shows a case where when the type of clothing is, for example, “outer,” a chest measurement, a hip measurement, a waist measurement and a shoulder measurement are used for calculation of the degree of dissimilarity among a plurality of parameters, and a height is not used for the calculation. FIG. 7 also shows a case where when the type of clothing is, for example, “skirt,” the waist measurement and the hip measurement are used for calculation of the degree of dissimilarity among the plurality of parameters, and the chest measurement, the shoulder measurement or the height is not used for the calculation. Furthermore, the third data may include unique parameters associated with respective clothing types or clothing IDs. For instance, when the clothing type is the tops or outer, the third data may further include a sleeve length as a corresponding parameter component. Moreover, when the clothing type is trousers, the third data may further include a leg length as a corresponding parameter component.

The fourth data includes clothing IDs and correction values arranged in association with each other. The correction values are each used for compensation of the body-shape parameter indicating the body shape of the first subject described later. The image processing apparatus 100 sets in advance a lower correction value, selected from a range of 0 to less than 1, for a higher degree by which clothing identified by clothing ID covers the body of the user. In contrast, the image processing apparatus 100 sets a correction value of 1 for the lowest degree by which clothing identified by clothing ID covers the body. Namely, the lower the degree of covering, the closer to 1 the correction value.

For instance, if clothing identified by clothing ID is a T-shirt or underwear that directly contacts the body of the user, 1 or a value close to 1 is preset in the fourth data as a correction value corresponding to the clothing ID. In contrast, if the clothing identified by the clothing ID is, for example, a sweater or coat that is formed of thick cloth and covers the body of the user by a higher degree, a value selected from a range from 0 to less than 1 and closer to 0 (for example, 0.3) is set in the fourth data as the correction value for the clothing ID.

The clothing ID and correction value included in the fourth data can be appropriately changed in accordance with, for example, a user instruction through the input module 14.

Returning again to FIG. 3, a description will be given of the functionality configuration of the image processing apparatus 100 of the embodiment. The image processing apparatus 100 is a computer including a central processing unit (CPU), a random access memory (RAM), a read-only memory (ROM), etc. The image processing apparatus 100 may include, for example, a circuit other than the CPU.

As shown in FIG. 3, the image processing apparatus 100 includes an image acquisition module 101, a skeletal frame data generator 102, a determination module 103, an acceptance module 104, a body-shape-parameter acquisition module 105, a posture data calculator 106, a selection module 107, an adjustment module 108, a position calculator 109, a decision module 110, a composite image generator 111, a display controller 112, and an update module 113. In the embodiment, part or all of the modules 101 to 113 may be realized by causing, for example, the CPU to execute a program, namely by software, or by hardware such as an integrated circuit, or by a combination of software and hardware.

The image acquisition module 101 includes subject-image acquisition module 101a and depth-image acquisition module 101b.

The subject-image acquisition module 101a sequentially acquires subject images of the first subject continuously imaged by first imaging module 15A. More specifically, subject-image acquisition module 101a acquires a subject image of the first subject by extracting a subject area from the subject image output from first imaging module 15A.

Depth-image acquisition module 101b sequentially acquires the depth image (depth map) of the first subject continuously imaged by second imaging module 15B. More specifically, depth-image acquisition module 101b acquires the depth image of the first subject by extracting a subject area from the depth image output from second imaging module 15B.

In this case, depth-image acquisition module 101b acquires the subject area by setting a threshold for a depth distance included in the three-dimensional positions of each pixel constituting a depth image. For instance, in a coordinate system of second imaging module 15B, assume that the position of the module 15B is the origin, and that the optical axis of the module 15B extends from the origin to a subject in a z-axis positive direction. In this case, pixels included in the pixels of the depth image and having positional coordinates, along the depth (z-axis), exceeding a preset threshold (for example, 2 m) are excluded. As a result, depth-image acquisition module 101b can acquire a depth image formed of pixels in a subject area that exists within a range of 2 m from second imaging module 15B, namely, can acquire a depth image of the first subject.

Although it is assumed in the embodiment that the depth image is acquired using second imaging module 15B, it may be created by a technique, such as stereo matching, from a subject image of the first subject.

The skeletal frame data generator 102 extracts skeletal frame data indicating the skeletal frame position of a human body (namely, the first subject) from the depth image of the first subject acquired by depth image acquisition module 101b. At this time, the skeletal frame data generator 102 extracts the skeletal frame data by applying the shape of the human body to the depth image.

Further, the skeletal frame data generator 102 transforms a coordinate system associated with the positions of pixels included in the extracted skeletal frame data (namely, the coordinate system of second imaging module 15B) into a coordinate system associated with the positions of pixels included in the subject image of the first subject acquired by subject-image acquisition module 101a (namely, the coordinate system of first imaging module 15A). In other words, the skeletal frame data generator 102 transforms a coordinate system corresponding to the positions of the pixels in the extracted skeletal frame data extracted from the depth image of the first subject imaged by second imaging module 15B, into a coordinate system corresponding to the positions of the pixels in the subject image of the first subject acquired by first imaging module 15A at the same acquisition time of the depth image. This coordinate system transformation is executed by, for example, calibration. As a result, the skeletal frame data generator 102 generates (calculates) the skeletal frame data (data obtained after coordinate transformation) of the first subject.

The determination module 103 determines whether the subject image acquired by subject-image acquisition module 101a satisfies a preset first condition. The first condition is used to determine whether calculation processing of a first position, described later, should be performed. Details of the first condition will be described later.

The acceptance module 104 accepts a variety of data from the input module 14. More specifically, the acceptance module 104 accepts the attribute data of clothing (the shape of clothing, the name of clothing, the distribution source of clothing, the color of clothing, the raw material of clothing, the price of clothing, etc.) in accordance with a user instruction through the input module 14.

The acceptance module 104 analyzes attribute data received from the input module 14, and searches the first data stored in the storage 16 for clothing ID corresponding to the received attribute data. As described above, in the first data, each clothing ID is associated with a plurality of clothing images corresponding to different clothing sizes, body-shape parameters, and posture data items. Accordingly, the acceptance module 104 reads, from the first data, one clothing image corresponding to each clothing ID as a typical clothing image corresponding to each clothing ID, the one clothing image having one typical clothing size, one typical body-shape parameter, and one typical posture data item. A list of clothing images is displayed on the display module 12 and presented to the user.

The one typical clothing size, the one typical body-shape parameter, and the one typical posture data item retrieved by the acceptance module 104 are supposed to be predetermined. Further, the acceptance module 104 may set a clothing size accepted through the input module 14 as the one typical clothing size.

When a list of clothing images is displayed on the display module 12, the user selects, from the list, clothing (clothing image) for trial fitting by performing an instruction through the input module 14. As a result, the clothing ID of the selected clothing image is output from the input module 14 to the image processing apparatus 100. The clothing size is also input by a user instruction through the input module 14.

The acceptance module 104 accepts the selected clothing ID and the selected clothing size through the input module 14. In other words, the acceptance module 104 accepts clothing ID for trial fitting, and the clothing size for trial fitting.

It is sufficient if the acceptance module 104 at least acquires the clothing ID of clothing for trial fitting, and may not accept the clothing size for trial fitting. That is, it is sufficient if the user inputs clothing ID through the input module 14, and may not input the clothing size.

The body-shape parameter acquisition module 105 acquires a body-shape parameter indicating the body shape of the first subject (hereinafter, referred to as the body-shape parameter of the first subject). This body-shape parameter includes one or more parameter components, like the above-described body-shape parameter included in the first data.

In this case, the body-shape parameter acquisition module 105 acquires, via, for example, the acceptance module 104, the body-shape parameter input in accordance with, for example, a user instruction through the input module 14.

More specifically, the input screen for, for example, the body-shape parameter of the first subject is displayed on the display module 12. This input screen includes parameter input columns for a chest measurement, a waist measurement, a hip measurement, a height, a shoulder measurement, a weight, etc. The user inputs values in the parameter columns by operating the input module 14, referring to the input screen displayed on the display module 12. The acceptance module 104 outputs, to the body-shape parameter acquisition module 105, the body-shape parameter received from the input module 14. The body-shape parameter acquisition module 105 acquires the body-shape parameter from the acceptance module 104.

The body-shape parameter acquisition module 105 may estimate the body-shape parameter of the first subject. In the embodiment, it is assumed that the body-shape parameter acquisition module 105 estimates the body-shape parameter of the first subject.

In this case, the body-shape parameter acquisition module 105 estimates the body-shape parameter of the first subject from the depth image of the first subject acquired by depth image acquisition module 101b.

Further, the body-shape parameter acquisition module 105 applies the three dimensional model data of a human body to the depth image of the first subject, for example. The body-shape parameter acquisition module 105 calculates each parameter-component value (for example, the height, the chest measurement, the waist measurement, the hip measurement or the shoulder measurement) included in the body-shape parameter, using the depth image and the three dimensional model data applied to the depth image.

Yet further, the body-shape parameter acquisition module 105 acquires the weight of the first subject as (a parameter component included in) the body-shape parameter of the first subject. The weight of the first subject can be acquired from the weight measuring module 13, for example. The weight of the first subject may be acquired in accordance with, for example, a user instruction through the input module 14.

Thus, the body-shape parameter acquisition module 105 can acquire the body-shape parameter of the first subject that includes the above-mentioned estimated parameter and the weight.

The body-shape parameter acquisition module 105 may have a structure in which the weight of the first subject is not acquired. In this case, the body-shape parameter acquisition module 105 acquires a body-shape parameter that includes parameter components other than the weight.

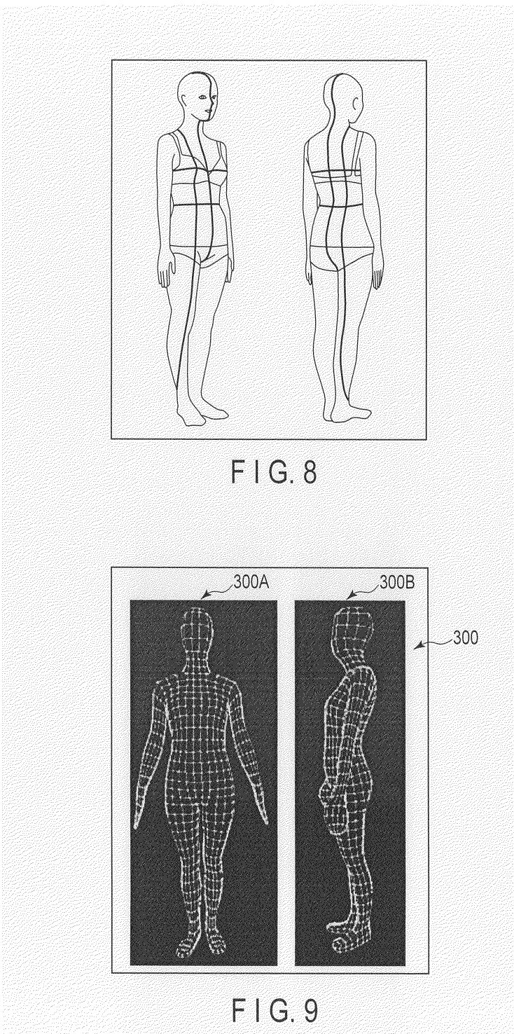

Referring now to FIGS. 8 and 9, a description will be given of estimate of a body-shape parameter by the body-shape parameter acquisition module 105. FIG. 8 shows an example of the three dimensional model data of a human body. FIG. 9 shows images (model images) 300 obtained by applying the three dimensional model data to the depth image of the first subject. Model image 300A of FIG. 9 shows a three dimensional model of the back of the first subject. Model image 300B of FIG. 9 shows a three dimensional model of a side of the first subject.

More specifically, the body-shape parameter acquisition module 105 applies the three dimensional model data (three-dimensional polygon model) of a human body to the depth image of the first subject. The body-shape parameter acquisition module 105 estimates the above-mentioned measurement values, based on distances from respective portions of the three-dimensional model data applied to the depth image of the first subject, which correspond to the parameter components (the height, the chest measurement, the waist measurement, the hip measurement, the shoulder measurement, etc.). Namely, the body-shape parameter acquisition module 105 calculates the parameter values of the height, the chest measurement, the waist measurement, the hip measurement, the shoulder measurement, etc., based on, for example, the distances between vertexes in the three-dimensional model data of the human body applied to the depth image, and based on ridgelines connecting respective pairs of vertexes. The respective pairs of vertexes each indicate one end and the other end of a portion of the three-dimensional model data of the human body applied to the depth image, which portion corresponds to each of the computation target parameter components. It is sufficient if the same computation as the above is executed on each parameter component included in the body-shape parameter of the second subject.

It is preferable that the body-shape parameter acquisition module 105 corrects the body-shape parameter components estimated from the depth image, so that the higher the degree of covering a body shape the clothing identified by clothing ID accepted by the acceptance module 104, the lower the value of each parameter component.

In this case, the body-shape parameter acquisition module 105 reads, from the fourth data stored in the storage 16, the correction value corresponding to clothing ID accepted by the acceptance module 104. The body-shape parameter acquisition module 105 corrects the value of each parameter component by multiplying, by the read correction value, each parameter component included in the body-shape parameter estimated from the depth image.

For example, when the first subject wearing heavy clothing is imaged by the imaging module, the value of a body-shape parameter component estimated by the body-shape parameter acquisition module 105 from the depth image may differ from the actual body shape of the first subject. In view of this, it is preferable that the body-shape parameter estimated by the body-shape parameter acquisition module 105 should be corrected.

In the embodiment, correction is performed, assuming, for example, that clothing corresponding to clothing ID (i.e., clothing ID of a trial fitting target received from the user) accepted by the acceptance module 104 is currently worn by the first subject. As described above, the correction value is set to 1 when the degree by which the body is covered with the clothing is lowest, and is set to a value closer to 0 when the degree is higher. By this correction, the body-shape parameter acquisition module 105 can estimate a body-shape parameter that indicates a more accurate body shape of the first subject.

The above-described correction processing may be executed, when an instruction button is displayed on the display module 12 for instructing correction, and the instruction button has been designated (operated) in accordance with a user instruction through the input module 14.

Returning to FIG. 3, the posture data calculator 106 calculates the posture data of the first subject. The posture data calculator 106 calculates the posture data of the first subject from the skeletal frame data of the first subject generated by the skeletal frame data generator 102. In this case, the posture data calculator 106 calculates the angle (orientation) of the first subject from the position of each joint indicated by the skeletal frame data of the first subject.

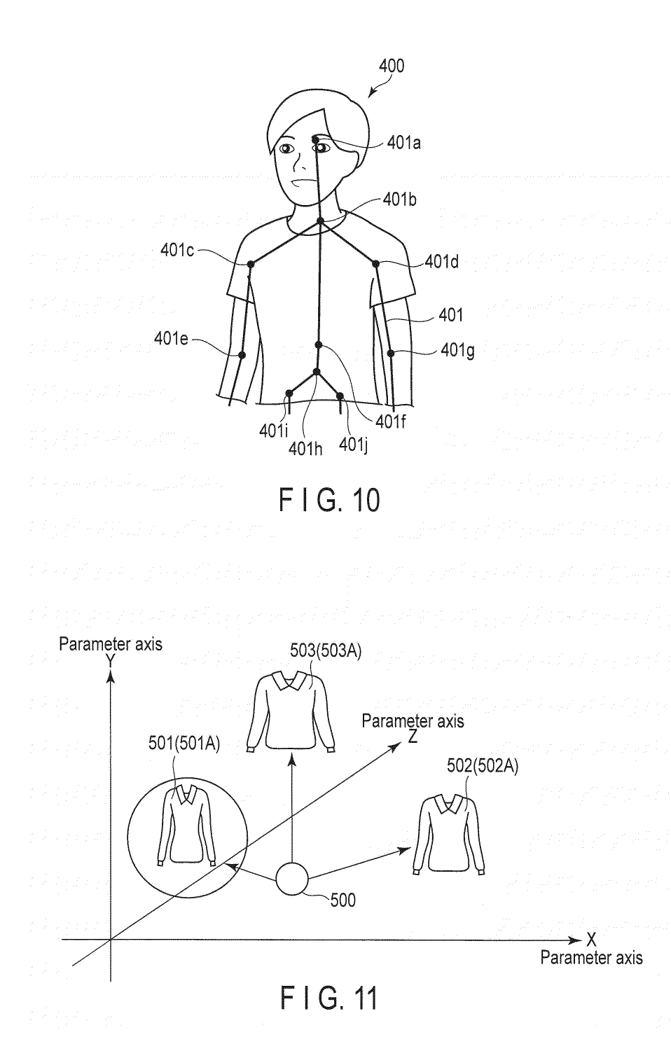

Referring then to FIG. 10, calculation of the posture data by the posture data calculator 106 will be described.

The coordinate data of the position (pixel position 401d in FIG. 10) of a pixel corresponding to the left shoulder of the first subject is set to Psl in the coordinate system of first imaging module 15A. Similarly, the coordinate data of the position (pixel position 401c in FIG. 10) of a pixel corresponding to the right shoulder of the first subject is set to Psr in the coordinate system of first imaging module 15A.

The posture data calculator 106 calculates, from these coordinate data items, the angle of the first subject with respect to the first imaging module 15A, using the following equation (1).

Angle of the first subject=arctan(Psl.z−Psr.z/Psl.x−Psr.x) (1)

In equation (1), Psl.z is the z-coordinate of the pixel corresponding to the left shoulder of the first subject, and Psr.z is the z-coordinate of the pixel corresponding to the right shoulder of the first subject. Similarly, in equation (1), Psl.x is the x-coordinate of the pixel corresponding to the left shoulder of the first subject, and Psr.x is the x-coordinate of the pixel corresponding to the right shoulder of the first subject.

The posture data calculator 106 can compute the angle of the first subject (i.e., the angle of rotation of the first subject) as posture data by the above calculation processing.

Returning to FIG. 3, the selection module 107 selects (specifies), as an output target, a clothing image included in a plurality of clothing images corresponding to clothing ID that is included in the first data stored in the storage 16 and is accepted by the acceptance module 104. The output target is a target to be output to the display module 12, an external device, etc. When the destination of output is the display module 12, the output target means a display target.

To facilitate the following description, a body-shape parameter (i.e., the body-shape parameter of the first subject) acquired by the body-shape parameter acquisition module 105 is called a first body-shape parameter. In contrast, a body-shape parameter included in the first data stored in the storage 16 is called a second body-shape parameter.

In this case, the selection module 107 selects clothing images that are included in the clothing images corresponding to clothing ID in the first data accepted by the acceptance module 104, and correspond to second body-shape parameters having degrees of dissimilarity not more than a threshold with respect to the first body-shape parameter. The degree of dissimilarity indicates that between the first body-shape parameter and each of the second body-shape parameters. The lower the degree of dissimilarity, the higher the degree of similarity between the first and second body-shape parameters. In other words, the higher the degree of dissimilarity, the lower the degree of similarity therebetween.

The selection module 107 calculates the degree of dissimilarity with respect to the first body-shape parameter, for each second body-shape parameter that is included in the first data stored in the storage 16 and corresponds to the clothing ID accepted by the acceptance module 104. In the embodiment, the difference between the first and second body-shape parameters is used as a degree of dissimilarity.

In this case, the selection module 107 calculates the difference between the first and second body-shape parameters, using, for example, norm L1 or L2.

When using norm L1, the selection module 107 calculates the difference (hereinafter, referred to as the first differences) between the values of the same parameter components included in the first body-shape parameter and each of the second body-shape parameters corresponding to clothing ID accepted by the acceptance module 104. The selection module 107 calculates the sum of the absolute values of the first differences between the values of the same parameter components included in the first body-shape parameter and the respective second body-shape parameters, as the difference (i.e., the degree of dissimilarity) between the first body-shape parameter and each of the second body-shape parameters.

More specifically, when using norm L1, the selection module 107 calculates the degree of dissimilarity using the following equation (2). Equation (2) is directed to a case where each of the first and second body-shape parameters includes, as components, a height, a chest measurement, a waist measurement, a hip measurement, a shoulder measurement, and a weight.

Degree of dissimilarity=|A1−A2|+|B1−B2|+|C1−C2|+|D1−D2|+|E1−E2|+|F1−F2| (2)

In equation (2), A1 indicates the height of the first subject included in the first body-shape parameter, and A2 indicates a height included in each of the second body-shape parameters. B1 indicates the chest measurement of the first subject included in the first body-shape parameter, and B2 indicates a chest measurement included in each of the second body-shape parameters. C1 indicates the waist measurement of the first subject included in the first body-shape parameter, and C2 indicates a waist measurement included in each of the second body-shape parameters. D1 indicates the hip measurement of the first subject included in the first body-shape parameter, and D2 indicates a hip measurement included in each of the second body-shape parameters. E1 indicates the shoulder measurement of the first subject included in the first body-shape parameter, and E2 indicates a shoulder measurement included in each of the second body-shape parameters. F1 indicates the weight of the first subject included in the first body-shape parameter, and F2 indicates a weight included in each of the second body-shape parameters.

In contrast, when using norm L2, the selection module 107 calculates, as the difference (i.e., the degree of dissimilarity) between the first body-shape parameter and each of the second body-shape parameters, the sum of the square values of the absolute values of the differences (i.e., the first differences) between the values of the same parameter components included in the first body-shape parameter and the respective second body-shape parameters.

More specifically, when using norm L2, the selection module 107 calculates the degree of dissimilarity using the following equation (2). Equation (2) is directed to a case where each of the first and second body-shape parameters includes, as components, a height, a chest measurement, a waist measurement, a hip measurement, a shoulder measurement, and a weight.

Degree of dissimilarity=A1−A2|²+|B1−B2|²+|C1−C2|²+|D1−D2|²+|E1−E2|²+|F1−F2|² (3)

Since A1, A2, B1, B2, C1, C2, D1, D2, E1, E2, F1 and F2 in equation (3) are similar to those in the above-mentioned equation (2), they will not be described in detail.

For the calculation of the degree of dissimilarity (in the embodiment, the difference), a transform function may be applied to the degree of dissimilarity so that the weight set for each parameter component of, for example, each second-body parameter will be greater when the value (subtraction value) obtained by subtracting a parameter included in the first-body parameter from a corresponding parameter included in each second-body parameter is greater than 0, than when the subtraction value is less than 0.

By this processing, the image processing apparatus 100 can suppress such a display as in which when a composite image obtained by combining a subject image of the first subject with a clothing image is displayed, the clothing image is displayed relatively larger than the first subject.

Further, the degree of dissimilarity may be computed, after the value of each parameter component included in the first body-shape parameter and each of the second body-shape parameters are changed in accordance with the weights included in the second data stored in the storage 16. In this case, the selection module 107 reads, from the second data, the weights of a plurality of parameter components corresponding to clothing ID accepted by the acceptance module 104. Before the calculation of the above-mentioned difference, the selection module 107 calculates a multiplication value by multiplying the value of each parameter component included in the first and second parameters by a corresponding weight. The selection module 107 calculates the degree of dissimilarity, using the computed multiplication value corresponding to each parameter component as each parameter component value.

As described above, the weighted values are included in the second data and indicate the degrees of influence in vision when clothing items identified by corresponding clothing ID are worn. Accordingly, when computation of a degree of dissimilarity considering a weighted value is carried out, a more appropriate degree of dissimilarity can be acquired, with the result that a clothing image more appropriate to the body shape of the first subject can be selected.

Further, the selection module 107 may compute a weighted value for each parameter component, and may replace a corresponding weighted value indicated by the second data with the computed weighted value.

In this case, the selection module 107 calculates weighted values for respective parameter components in accordance with the posture data of the first subject computed by the posture data calculator 106.

More specifically, assuming that the posture data of the first subject computed by the posture data calculator 106 indicates that the first subject is just directed to first imaging module 15A (the first subject is facing the front with respect to the imaging module 15A), the selection module 107 sets weighted values for the shoulder measurement and the height to relatively greater values than the weighted values for the other parameter components.

This is because the shoulder measurement and the height of the first subject can be more accurately estimated from a depth image acquired by imaging the first subject from the front, than the other parameter components, compared to a case where the depth image is acquired from a direction other than the front.

Moreover, the weight of the first subject is input through the weight measuring module 13 or the input module 14. Namely, since an accurate value can be also acquired for the weight of the first subject, compared to the other parameters, the selection module 107 also sets a higher weighted value for the weight than the weighted values for the other parameter components.

By thus setting a relatively higher weighted value, than those for the other parameter components, for a parameter component whose accurate value can be acquired, a more accurate dissimilarity degree can be computed.

In addition, the selection module 107 may compute the degree of dissimilarity, using some parameter components among a plurality of parameter components included in the first body-shape parameter and each second body-shape parameter.

More specifically, the selection module 107 reads, from the third data, a parameter component that is used for calculation of the degree of dissimilarity, is included in the parameter components of the first and second body-shape parameters, and corresponds to a type of clothing corresponding to the clothing ID accepted by the acceptance module 104. It is sufficient if the clothing ID corresponding to the type of clothing is read from the first data. When a parameter component used for the calculation of the degree of dissimilarity is set for each clothing ID, the selection module 107 reads, from the third data, a parameter component used for the calculation of the degree of dissimilarity corresponding to clothing ID accepted by the acceptance module 104. Thus, the selection module 107 can compute the degree of dissimilarity, using a parameter component that is included in the parameter components of the first and second body-shape parameters, is used for the calculation of the degree of dissimilarity, and is read from the third data.

When the parameter components included in the first body-shape parameter are not completely the same as those of the second body-shape parameter, the selection module 107 should compute the degree of dissimilarity, using a parameter included in common in the first and second body-shape parameters.

By the above processing, the selection module 107 calculates the degree of dissimilarity between the first body-shape parameter and each of the second body-shape parameters corresponding to clothing ID in the first data accepted by the acceptance module 104.

The selection module 107 specifies a second body-shape parameter whose a degree of dissimilarity was computed at values not more than a threshold. Namely, the selection module 107 specifies, among the second body-shape parameters corresponding to the clothing ID in the first data accepted by the acceptance module 104, a second body-shape parameter similar to the first body-shape parameter.

As described above, the degree of dissimilarity indicates that between the first and second body-shape parameters. Accordingly, the lower the degree of dissimilarity between the first and second body-shape parameters, the higher the degree of similarity therebetween.

The selection module 107 specifies the second body-shape parameter whose computed dissimilarity degree is not more than the threshold. It is assumed that the threshold for the degree of dissimilarity is predetermined. Further, the threshold for the degree of dissimilarity can be arbitrarily changed in accordance with, for example, a user instruction through the input module 14.

Thus, the selection module 107 selects, as output targets, a clothing image corresponding to the specified second body-shape parameter.

As described above, the first data stored in the storage 16 includes a plurality of clothing images that correspond to the second body-shape parameter whose degrees of dissimilarity are determined to be not more than the threshold, and also correspond to different posture data items (indicating the orientations of the first subject).

Therefore, the selection module 107 selects, as output targets, a clothing image that are included in the clothing images that correspond to the second body-shape parameter whose degrees of dissimilarity are determined to be not more than the threshold, and also correspond to posture data (the rotational angle of the first subject) calculated by the posture data calculator 106.

Referring then to FIG. 11, a description will be given of selection of a clothing image by the selection module 107. FIG. 11 is directed to a case where three parameter components included in each of the first and second body-shape parameters are each indicated using x-, y- and z-coordinates.

In FIG. 11, it is assumed that the first body-shape parameter acquired (estimated) by the body-shape parameter acquisition module 105 is a first body-shape parameter 500. It is also assumed that a plurality of second body-shape parameters corresponding to clothing ID accepted by the acceptance module 104 are second body-shape parameters 501 to 503. It is further assumed that among the second body-shape parameters 501 to 503, a second body-shape parameter whose degree of dissimilarity with respect to the first body-shape parameter 500 is not more than a threshold is the second body-shape parameter 501 that is at a closest distance in FIG. 11. In this case, the selection module 107 specifies the second body-shape parameter 501.

Subsequently, the selection module 107 selects, as an output target, clothing image 501A corresponding to the specified second body-shape parameter 501, among clothing images 501A to 503A that correspond to the second body-shape parameters 501 to 503, respectively.

When the selection module 107 specifies (clothing images corresponding to) a plurality of second body-shape parameters whose degrees of dissimilarity are not more than the threshold, it is sufficient if the selection module 107 selects, as the output target, a clothing image corresponding to a second body-shape parameter whose degree of dissimilarity is lowest.

Further, the selection module 107 may select a clothing image, considering a clothing size accepted by the acceptance module 104 through the input module 14. In this case, the selection module 107 should select, among clothing images corresponding to clothing ID and size accepted by the acceptance module 104, that corresponding to second body-shape parameter whose a degrees of dissimilarity is not more than the threshold.

When selecting a clothing image as an output target, the selection module 107 uses the posture data of the first subject and posture data included in the first data, as described above.

In this case, the selection module 107 selects, as the output target, a clothing image that is included in clothing images corresponding to clothing ID accepted by the acceptance module 104 and corresponds to posture data (the rotational angle of the first subject) calculated by the posture data calculator 106. This selection processing of a clothing image is executed when a tracking mode (first operation mode) is set in the image processing system 10 (image processing apparatus 100). The tracking mode is a mode for presenting (displaying), to a user, a composite image indicating a state where clothing is fitted on the user.

The selection module 107 can also select, as an output target, a clothing image corresponding to a rotational angle different from the rotational angle of the first subject, based on the rotational angle of the first subject calculated by the posture data calculator 106, which will be described later in detail. This selection processing is performed when a full-length mirror mode (second operation mode) is set in the image processing system 10 (image processing apparatus 100). The full-length mirror mode is a mode for presenting (displaying), to the user, a composite image indicating a state where the user can more easily check the mood of clothing for trial fitting, than in the above-mentioned tracking mode.

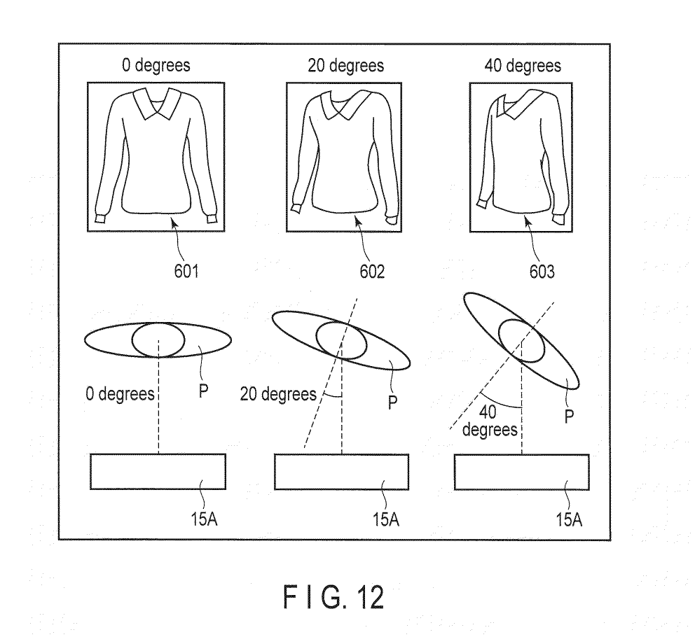

FIG. 12 conceptually shows the posture data included in the first data. It is assumed that clothing images 601 to 603, which correspond to respective posture data items of “±0 degree,” “+20 degrees” and “+40 degrees,” as is shown in FIG. 12, are pre-registered in the storage 16 (i.e., are beforehand included in the first data stored in the storage 16) as clothing images corresponding to a second-body parameter whose degree of dissimilarity is not more than a threshold (e.g., the second-body parameter 501 in FIG. 11). The term “±0 degrees” indicates that the clothing image is angled by 0 degrees with respect to first imaging module 15A provided on the housing 11. Similarly, the term “+20 degrees” indicates that the clothing image is angled rightward by 20 degrees, and the term “+40 degrees” indicates that the clothing image is angled rightward by 40 degrees. It is also assumed that the rotational angle (i.e., the orientation) of the first subject calculated by the post data calculator 106 is +20 degrees.

When the tracking mode is set in the image processing system 10, the selection module 107 selects, as an output target, the clothing image 602 included in the clothing images 601 to 603 corresponding to second body-shape parameters of the first data that correspond to clothing ID accepted by the acceptance module 104, and have a degree of dissimilarity not more than the threshold, the clothing image 602 corresponding to the posture data (indicating that the rotational angle of the first subject is +20 degrees) calculated by the posture data calculator 106.

In contrast, when the full-length mirror mode is set in the image processing system 10, the selection module 107 selects, as the output target, a clothing image included in the clothing images 601 to 603 corresponding to clothing ID accepted by the acceptance module 104 and a second body shape parameter having a degree of dissimilarity not more than the threshold, the clothing image corresponding to an angle of, for example, +40 degrees, which differs from the rotational angle, +20 degrees, of the first subject included in the posture data calculated by the posture data calculator 106.

Namely, in the embodiment, a clothing image corresponding to different posture data is selected as output targets in accordance with operation modes set in the image processing system 10 (image processing apparatus 100). The selection processing of a clothing image in each operation mode will be described later in detail. The operation modes can be switched by, for example, a user instruction input through the input module 14.

The selection module 107 may have a structure in which, for example, second body-shape parameters are stepwise narrowed down for selecting a clothing image as an output target.

In this case, the selection module 107 calculates a degree of dissimilarity associated with one parameter component included in each of the first and second body-shape parameters, and specifies second body-shape parameters whose degrees of dissimilarity are not more than a threshold. Subsequently, the selection module 107 calculates a degree of dissimilarity associated with a component not yet used in the preceding selection and included in the specified second body-shape parameters, and specifies second body-shape parameters whose degrees of dissimilarity are not more than the threshold. The selection module 107 repeatedly carries out a series of processing like the above, with parameter components switched one by one, until a predetermined number of second body-shape parameters are specified. Thus, the selection module 107 may select (a clothing image corresponding to) the second body-shape parameter stepwise.

When stepwise specifying the second body-shape parameters as the above, the selection module 107 may use one parameter component or a plurality of parameter components in each step.

Alternatively, the selection module 107 may stepwise specify the second body-shape parameter, using parameter components of weighted values shown in, for example, FIG. 6, beginning with a parameter component of the highest weighted value.

Further, the type of parameter used in each step may be pre-stored in the storage 16. That is, the storage 16 stores data indicating a respective step in association with data indicating the type of parameter component used in the respective step. This structure enables the selection module 107 to read, from the storage module 16, (data indicating) the type of parameter component used in each step, thereby stepwise specifying the second body-shape parameter using the parameter components.

Furthermore, when selecting a plurality of clothing images as output targets in each step or in the last step, the selection module 107 may set, as the output target, one clothing image selected by the user from the selected clothing images. More specifically, the display controller 112 displays, on the display module 12, a list of clothing images selected by the selection module 107. In this case, the user can choose one clothing image as an output target by operating the input module 14 while browsing the list of clothing images on the display module 12. As a result, the selection module 107 can select, as an output target, a clothing image selected by the user from a plurality of clothing images displayed on the display module 12.

Moreover, when a plurality of clothing images are selected, one clothing image may be selected as an output target during template matching processing described later. More specifically, in the embodiment, before a clothing image as an output target and a subject image are combined, template matching using the feature area (for example, the shoulder area) of the clothing image and the feature area (for example, the shoulder area) of the depth image of the first subject is performed. In this case, a clothing image included in the clothing images selected by the selection module 107, in which the shoulder area exhibits a highest degree of similarity with the shoulder area of the depth image of the first subject, may be selected as one output target.

One or more clothing images selected by the selection module 107 may be displayed on the display module 12 before they are combined with the subject image. The clothing images displayed on the display module 12 are assumed to be images showing a state where, for example, the above-mentioned second subject wears corresponding clothing.

The above structure enables the user (first subject) to check a state in which clothing designated as a target of trial fitting by the first subject is worn by a second subject similar or identical in shape to the first subject.

It is assumed here that when a clothing ID for identifying clothing for trial fitting and a clothing size have been accepted by the acceptance module 104 through the input module 14, a clothing image indicating a state where the clothing of the clothing size is worn by a second subject having a body shape identical or similar to that of the first subject is displayed on the display module 12. As a result, the user (first subject) can check a state in which clothing of the clothing size designated as a target of trial fitting by the first subject is worn by a second subject similar or identical in shape to the first subject.

Namely, by thus displaying, on the display module 12, one or more clothing images selected by the selection module 107 before they are combined with a subject image, a clothing image indicating a trial-fitting state corresponding to the body shape of the first subject can be presented (offered) to the user, even before combining of the clothing images with the subject image.

Returning again to FIG. 3, the adjustment module 108 transforms the coordinate system of the depth image of the first subject (i.e., the coordinate system of second imaging module 15B) acquired by depth image acquisition module 101b, into the coordinate system of the subject image of the first subject (i.e., the coordinate system of first imaging module 15A) acquired by subject-image acquisition module 101a. The adjustment module 108 adjusts the resolution of the depth image of the first subject to the same resolution as that of the subject image, by executing projection so that pixels, which constitute the depth image of the first subject after the coordinate transform, are positioned in positions corresponding to those of the pixels constituting the subject image of the first subject acquired at the same time as the depth image.

For example, assume that the resolution of a depth image acquired by second imaging module 15B (i.e., a depth image acquired by depth image acquisition module 101b) is 640×480 pixels, and that the resolution of a subject image obtained by the first imaging module 15A (i.e., a subject image obtained by subject-image acquisition module 101a) is 1080×1920 pixels. In this case, when each pixel which constitutes a depth image is projected on the subject image as a point of 1 pixel×1 pixel, clearances will occur between the pixels. In view of this, in the adjustment module 108, a Gaussian filter or a filter, such as a morphologic operation, is applied when necessary, thereby adjusting the pixels so that no clearances will occur between the pixels constituting the depth image projected on the subject image.

The adjustment module 108 calculates the size of a feature area in a clothing image as an output target selected by the selection module 107, based on the clothing image and skeletal frame data included in posture data corresponding to the clothing image. Similarly, the adjustment module 108 calculates the size of a feature area in the subject image of the first subject, based on the resolution-adjusted depth image of the first subject, and the skeletal frame data of the first subject generated by the skeletal frame data generator 102.

The feature area is an area from which the shape of a human body can be estimated. As the feature area, a shoulder area corresponding to the shoulders of the human body, a waist area corresponding to the waist, a foot area corresponding to the length of a leg, etc., can be used. However, the feature area is not limited to them. Although the embodiment is directed to a case where the shoulder area corresponding to the shoulders of the human body is used as the feature area, any other area may be used as the feature area.

For instance, when the shoulder area corresponding to the shoulders of the human body is used as the feature area, the adjustment module 108 calculates the shoulder measurement in the output-target clothing image as the size of the feature area.

The adjustment module 108 scales up or down the output-target clothing image or the subject image, based on the calculated size of the feature area of the clothing image and the size of the feature area of the subject image acquired by the subject image acquisition module 101. As a result, scaling up or down is executed so that at least part of the outline of the clothing image coincides with at least part of the outline of the subject image.

The adjustment module 108 extracts feature areas (for example, shoulder areas) used to calculate a first position described later, from the scaled-up or scaled-down clothing image and subject image.

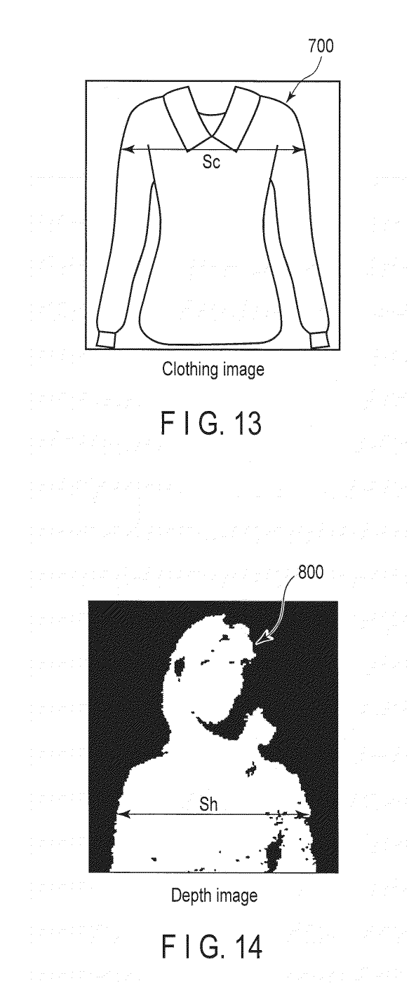

A detailed description will now be given of extraction of feature areas by the adjustment module 108. Referring first to FIGS. 13 and 14, calculation of the size of each of the above-mentioned feature areas will be described. Suppose here that the resolution of the depth image of the first subject acquired by depth image acquisition module 101b is adjusted to the same resolution as that of the subject image acquired by subject-image acquisition module 101a.

In this case, the adjustment module 108 calculates the average y-coordinate of pixel positions corresponding to the left and right shoulders in joint positions on a clothing image selected as an output target by the selection module 107, based on the skeletal frame data in the posture data corresponding to the clothing image. Subsequently, in the position (height) of a calculated y-coordinate, the adjustment module 108 performs searching from the x-coordinate of a pixel corresponding to the above-mentioned left shoulder, to an area corresponding to an outer portion of the clothing, thereby detecting an x-coordinate corresponding to the border of the left shoulder. Similarly, in the position (height) of the calculated y-coordinate, the adjustment module 108 performs searching from the x-coordinate of a pixel corresponding to the above-mentioned right shoulder, to an area corresponding to the other outer portion of the clothing, thereby detecting for an x-coordinate corresponding to the border of the right shoulder.

By detecting the difference between these two x-coordinates, the adjustment module 108 can determine a shoulder measurement (indicated by the number of pixels) Sc on such a clothing image 700 as shown in FIG. 13.

Alternatively, the shoulder measurement of the clothing image may be calculated by performing searching associated with a plurality of horizontal lines included in a certain range of y-coordinates that covers a y-coordinate corresponding to the position of the shoulder joint and y-coordinates above and below this y-coordinate, and obtaining averages of x-coordinates at the opposite sides of the plurality of horizontal lines, instead of calculating the shoulder measurement based on one y-coordinate determined from the y-coordinates of the pixels corresponding to the positions of the shoulder joints.

Subsequently, the adjustment module 108 calculates the shoulder measurement on the subject image of the first subject, using the depth image of the first subject adjusted to the same resolution as that of the first subject, and the skeletal frame data of the first subject (skeletal frame data generated by the skeletal frame data generator 102).

As shown in FIG. 14, the adjustment module 108 calculates the average y-coordinate of the y-coordinates of the pixel positions corresponding to the left and right shoulders and included in the depth image of the first subject. Subsequently, the adjustment module 108 executes searching from the x-coordinate of a pixel corresponding to the left shoulder, to an area corresponding to an outer portion of the first subject, thereby searching for an x-coordinate corresponding to one border of the first-subject area.

Similarly, the adjustment module 108 executes searching from the x-coordinate of a pixel corresponding to the right shoulder in the depth image of the first subject, to an area corresponding to the other outer portion of the first subject, thereby detecting an x-coordinate corresponding to the other border of the first-subject area.

By detecting the difference between these two x-coordinates, the adjustment module 108 can determine a shoulder measurement (indicated by the number of pixels) Sh on such a depth image (subject image) 800 as shown in FIG. 14.

Alternatively, the shoulder measurement of the subject image may be calculated by performing searching associated with a plurality of horizontal lines included in a certain range of y-coordinates that covers a y-coordinate corresponding to the position of the shoulder joint and y-coordinates arranged above and below this y-coordinate, and obtaining averages of x-coordinates detected at the opposite sides of the plurality of horizontal lines, instead of calculating the shoulder measurement based on one y-coordinate determined from the y-coordinates of the pixels corresponding to the positions of the shoulder joints.

Subsequently, the adjustment module 108 determines the scaling ratio of the clothing image, using the calculated sizes of the feature areas, i.e., the shoulder measurement Sc of the clothing image, and the shoulder measurement Sh of the subject image.

More specifically, the adjustment module 108 calculates, as a scaling ratio, a division value (Sh/Sc) obtained by dividing the shoulder measurement Sh of the subject image by the shoulder measurement Sc of the clothing image. The scaling ratio may be computed based on a different mathematical expression using values, such as actual sizes of clothing or the numbers of pixels equivalent to the width and the height of the clothing images area.

The adjustment module 108 scales up or down a clothing image as an output target, using a calculated scaling ratio. The adjustment module 108 also scales up or down skeletal frame data included in posture data corresponding to the clothing image as the output target, using the same scaling ratio.

Subsequently, the adjustment module 108 extracts the feature area used in the position calculator 109 from the scale-changed clothing image and the subject image.

The feature area is an area included in each of the clothing image and the subject image, from which area the shape of a human body can be estimated. The feature area is an area corresponding to, for example, the shoulders or waist of the human body. The embodiment is directed to a case where an area (shoulder area), which corresponds to the shoulders of the human body in the outlines of each of clothing images and the subject image, is extracted as the feature area.

Firstly, the adjustment module 108 extracts an outline from the depth image of the first subject adjusted to the same resolution as the subject image. The adjustment module 108 also extracts an outline from a clothing image scaled up or down as described above. From the thus-extracted outline, the adjustment module 108 extracts the outline of the shoulder area corresponding to the shoulders of a human body as the feature area. However, various methods other than the above can be used for outline extraction.

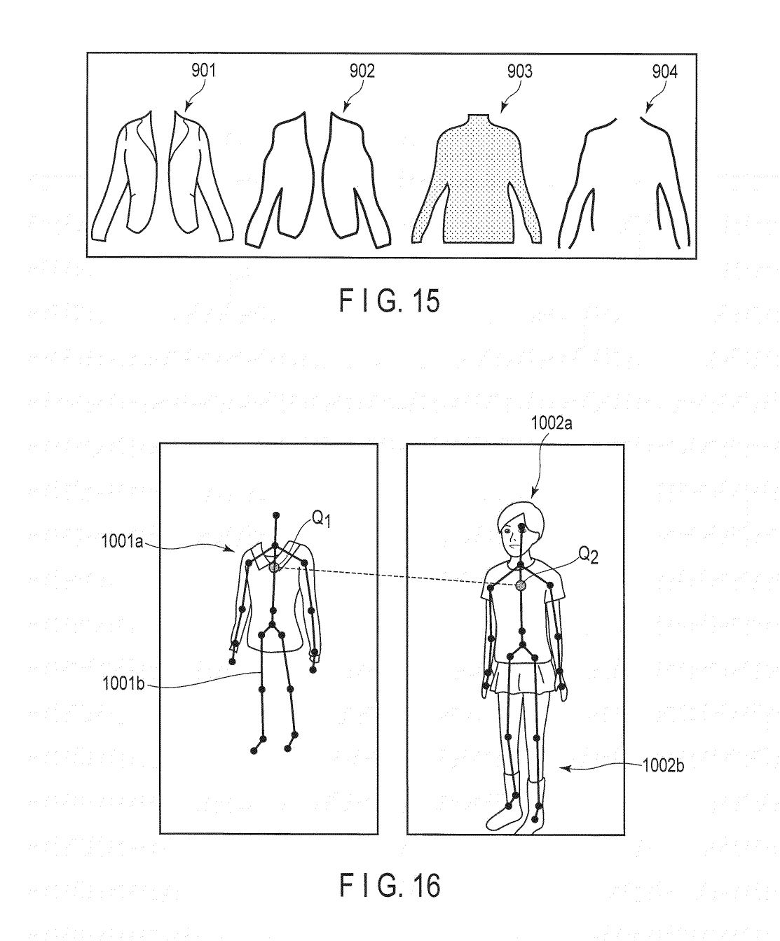

It is preferable that the adjustment module 108 should extract an outline in accordance with the shape of (a clothing area included in) a clothing image. Referring now to FIG. 15, a description will be given of an example of extraction of an outline.

Assume here that (a clothing area included in) an output-target clothing image 901 scaled up or down has an elongated opening in the front side of a human body. In the case of the clothing image 901, an outline 902 corresponding to the central portion of the human body is extracted as shown in FIG. 15. When template matching, described later, is executed using the outline 902, the matching accuracy of the area corresponding to the center portion of the human body may be degraded.

Because of this, it is preferable that the adjustment module 108 should delete an outline portion corresponding to the center portion from the outline 902 shown in FIG. 15, thereby extracting, from the clothing image, an outline portion along the outline of the human body.

In the image processing apparatus 100, it is supposed that when the update module 113, described later, registers each clothing image in the storage 16 (to include the same in the first data), the depth image of a second subject having worn for trial clothing corresponding to the clothing images is associated with the clothing image. The adjustment module 108 deletes, from a depth image, a part of an inside area connected to the outline of the depth image, utilizing, for example, image filtering processing such as a morphologic operation. By preparing a depth image 903 resulting from the deletion processing, the adjustment module 108 can delete an area (outline) overlapping with the depth image 903 from the outline 902, thereby extracting an outline 904 substantially equivalent to the outline of the human body, as is shown in FIG. 15.

The adjustment module 108 extracts, as the feature area, the shoulder area corresponding to the shoulders of the human body from the outlines of each of the clothing image as the output target extracted as described above, and the depth image (subject image).

There is a case where clothing included in the clothing images as output targets may be a tank top, a bare top, etc., and at this time, it is difficult to extract a shape (such as the outline of a shoulder) along the outline of the human body. In such a case, the depth image of a second subject wearing clothing as mentioned above may be pre-stored in the storage 16, and the outline of a shoulder area may be extracted (calculated) from the shoulders of the second subject.

Returning again to FIG. 3, the position calculator 109 calculates a first position of the clothing image on the subject image, the first position being where the position of the feature area of the clothing image extracted as the output target by the adjustment module 108 coincides with the position of the feature area of the subject image acquired by subject-image acquisition module 101a.

The position calculator 109 calculates the first position when the determination module 103 has determined that the subject image acquired by subject-image acquisition module 101a satisfies a first condition.

The position calculator 109 searches for the subject image (depth image) by executing template matching on the feature area of the subject image, using the feature area of the output-target clothing image as a template. Thus, the position calculator 109 calculates, as the first position, a position on the subject image (depth image) where the feature areas coincide with each other. For the template matching executed by the position calculator 109, various methods can be used.

The first position is indicated by position coordinates on the subject image. More specifically, the first position is determined to be the center of the feature area of the subject image when the feature area of the subject image coincides with the output-target clothing image.

Moreover, the position calculator 109 calculates a second position of the clothing image on the subject image, where a feature point in the output-target clothing image coincides with a feature point in the subject image.

The feature point is from where the shape of a human body can be estimated. The feature point is predetermined in accordance with a feature area. More specifically, the feature point is provided in a position corresponding to the center of the above-mentioned feature area. Namely, the feature point is beforehand set in accordance with an area used as the feature area. Further, the feature point is indicated by position coordinates on an image. When a shoulder area is used as the feature area in the embodiment, the center position in a shoulder area (i.e., a position corresponding to the center of the shoulders of a human body) is defined as the feature point.

Referring then to FIG. 16, a calculation example of the second position by the position calculator 109 will be described.

The position calculator 109 detects center position Q1 between both shoulders from skeletal frame data 1001b corresponding to clothing image 1001a as an output target shown in, for example, FIG. 16. The position calculator 109 also detects center position Q2 between both shoulders from skeletal frame data 1002b corresponding to subject image 1002a shown in FIG. 16 (i.e., skeletal frame data generated from subject image 1002a). The position calculator 109 calculates a second portion of clothing image 1001a on subject image 1002a, on which portion center position Q1 between both shoulders on clothing image 1001a as the output target coincides with center position Q2 between both shoulders on subject image 1002a. Namely, in the embodiment, the position calculator 109 calculates, as the second position, center position Q2 between both shoulders on subject image 1002a.

Returning again to FIG. 3, when the determination module 103 has determined that a subject image acquired by subject-image acquisition module 101a satisfies the first condition, the decision module 110 decides that the first position calculated by the position calculator 109 is a superposed position in which the output-target clothing image is superposed on the subject image.

In contrast, when the determination module 103 has determined that the subject image acquired by subject-image acquisition module 101a does not satisfy the first condition, the decision module 110 decides the superposed position, based on the difference between the first position calculated for a subject image acquired before the current subject image, and the second position (i.e., the second portion of clothing image 1001a) calculated from the subject image acquired before the current subject image by the position calculator 109.

More specifically, the decision module 110 decides, as the superposed position, a position acquired by shifting the second position calculated by the position calculator 109 based on the subject image acquired by subject-image acquisition module 101a, in accordance with the above-mentioned difference.

Namely, the difference used by the decision module 110 is the difference between the first position calculated by the position calculator 109 based on the subject image that was acquired before the subject image currently acquired by subject-image acquisition module 101a, and satisfies the first condition, and the second position calculated by the position calculator 109 from the subject image acquired before the currently-acquired subject image.

The composite image generator 111 generates a composite image by superposing an output-target clothing image selected by the selection module 107, on a superposed position decided by the decision module 110 on a subject image acquired by subject-image acquisition module 101a.

More specifically, the composite image generator 111 superposes an output-target clothing image in the superposed position on the subject image acquired by subject-image acquisition module 101a. Thus, the composite image generator 111 generates a composite image.

Namely, the composite image generator 111 refers to color values (Cr, Cg, Cb) and an alpha value (a) defined for each pixel of a clothing image selected by the selection module 107 and adjusted by the adjustment module 108. Alpha value (a) is a value falling within a range of 0 to 1. The composite image generator 111 also refers to color values (Ir, Ig, Ib) for each pixel of a subject image of the first subject. The composite image generator 111 generates a composite image by determining pixel values (color values and alpha values) using the following equation (4):

Ox=(1−a)×Ix+a×Cx (4)

where x indicates r, g or b. Moreover, when the clothing image occupies only part of the subject image of the first subject, the alpha value is calculated at “0” (a=0) in an area outside the occupied area of the clothing image.

As described above, the first position used when the composite image generator 111 generates a composite image is calculated by performing template matching of feature areas. The second position used when the composite image generator 111 generates a composite image is calculated from the position of a feature point. Therefore, when the first position is used, a composite image of a higher accuracy can be generated. In contrast, when the second position is used, the accuracy of the composite image becomes lower than when the first position is used. In this case, however, the composite image can be generated by a lower load, because a lower load is required for the generation of the second position than for the generation of the first position.

The display controller 112 displays various images on the display module 12. More specifically, the display controller 112 displays the above-mentioned list of clothing images, an input screen for inputting body-shape parameters indicating the body shapes of the first subject, composite images generated by the composite image generator 111, etc.

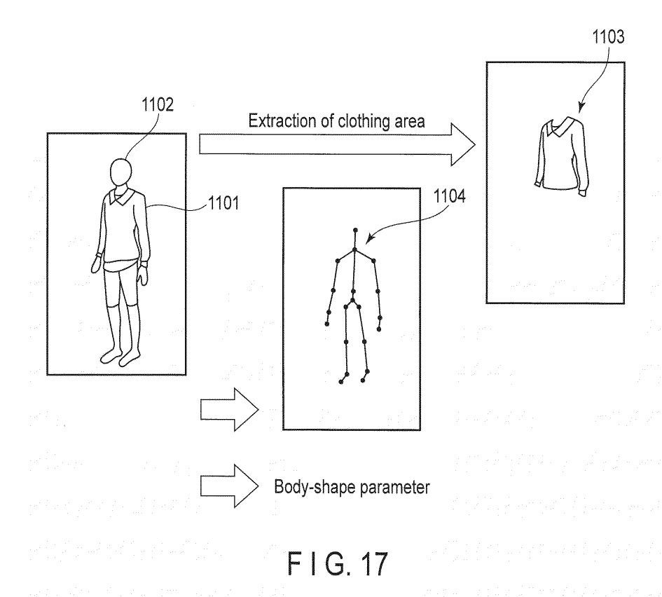

The updating module 113 performs registration and update of the first data as described above. Referring to FIG. 17, the registration and update of the first data by the updating module 113 will be described.

Firstly, clothing items corresponding to various sizes are prepared for each clothing ID. The clothing items of various sizes are worn by, for example, a plurality of second subjects of different body shapes. Namely, when the first data is registered and updated, a plurality of second subjects 1102, such as mannequins wearing respective clothing items 1101, are prepared as shown in FIG. 17. In FIG. 17, for facilitating the description, only one clothing item 1101 and only one second subject 1102 are shown.

By imaging the second subject 1102 wearing clothing 1101 by the same device as the imaging module in the image processing system 10, s subject image and a depth image of the second subject 1102 can be acquired. The updating module 113 extracts a clothing image by extracting a clothing area from the thus-obtained subject image. More specifically, the updating module 113 sets a mask indicating the clothing area. Using the mask, the updating module 113 extracts a plurality of clothing images 1103 indicating states where the second subjects 1102 of different body shapes wear clothing items 1101 of different sizes, as shown in FIG. 17. In FIG. 17, only one clothing image 1103 is shown for convenience, as mentioned above.

Moreover, as shown in FIG. 17, the updating module 113 calculates skeletal frame data of the second subject 1102, like the skeletal frame data generator 102, and calculates posture data of the second subject 1102, like the posture data calculator 106.

Furthermore, the updating module 113 acquires, from a depth image, a body-shape parameter indicating the body shape of the second subject 1102, like the body-shape parameter acquisition module 105. The body-shape parameter may be acquired by, for example, a user operation through the input module 14, or may be estimated using another depth image obtained by imaging the second subject 1102 wearing clothing (such as underwear) that clarifies the body line. Since this parameter estimation is similar to the above-described estimation of the first body-shape parameter by the body-shape parameter acquisition module 105, it is not described in detail.

The first data, which includes the clothing ID for identifying the above-mentioned clothing 1101, the clothing size of the clothing 1101, the acquired body-shape parameter (second body-shape parameter), the model ID of the second subject 1102, the calculated posture data, and the extracted clothing image, in association with each other, is stored in the storage 16. Thus, the first data is registered or updated. This processing is performed whenever each of the second subjects 1102 wearing respective clothing items 1101 of different sizes is imaged. When the updating module 113 can accept the type or attribute data of clothing input by a user instruction through the input module 14, it may be associated with clothing ID in the first data.

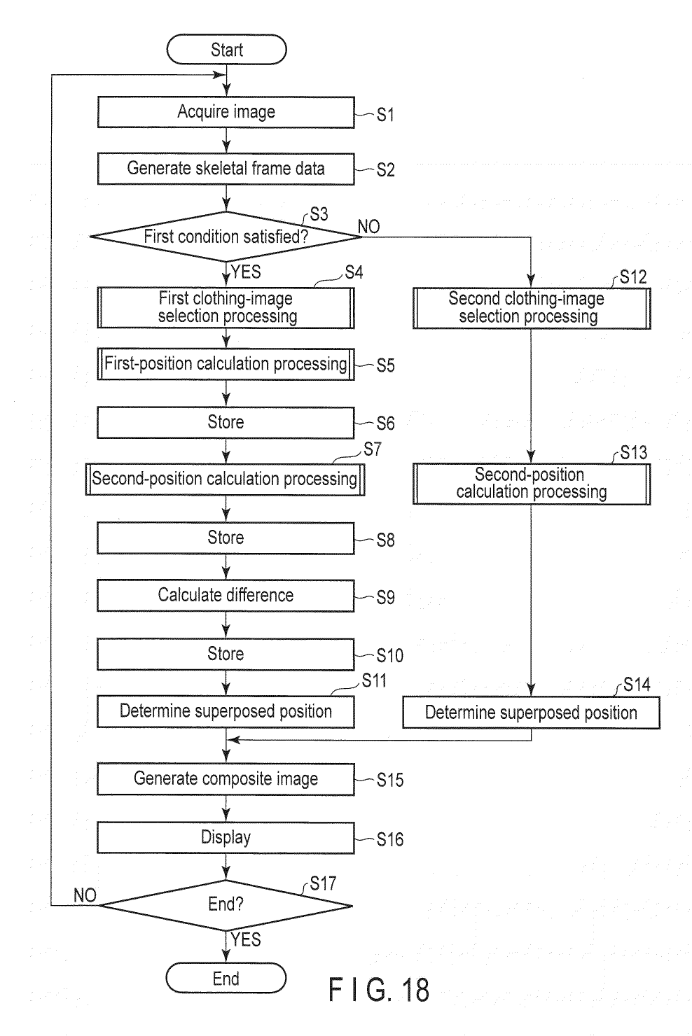

Referring then to the flowchart of FIG. 18, a processing procedure of the image processing apparatus 100 according to the embodiment will be described. The processing shown in FIG. 18 is performed whenever it accepts one subject image and depth image from the imaging module (first imaging module 15A and second imaging module 15B) incorporated in the image processing system 10. When the image processing apparatus 100 accepts a video image including a plurality of frames from the imaging module, the apparatus 100 executes the processing of FIG. 18 for each frame.

Firstly, subject-image acquisition module 101a and depth image acquisition module 101b acquire a subject image and a depth image, respectively (step S1). The subject image and the depth image acquired in step S1 will be hereinafter referred to as a target subject image and a target depth image, for convenience.

Subsequently, the skeletal frame data generator 102 generates the skeletal frame data of the first subject from the target depth image (step S2). More specifically, the skeletal frame data generator 102 extracts skeletal frame data from the target depth image, and generates the extracted skeletal frame data of the first subject by transforming the coordinate system (namely, the coordinate system of second imaging module 15B) of the skeletal frame data into the coordinate system of first imaging module 15A.

Subsequently, the determination module 103 determines whether the target subject image fulfills the first condition (step S3).

The first condition is, for example, that the first subject existing in an area imaged by the imaging module (hereinafter, referred to as the imaging area) is switched from one to another. That is, when the first subject is switched from one to another, it is determined in step S3 that the target subject image does not satisfy the first condition. In contrast, when the first subject is not replaced with another, namely, when, for example, the first subject remains in the imaging area to confirm a composite image indicating a state where the first subject wears desired closing, it is determined in step S3 that the target subject image does not satisfy the first condition. In other words, unless the first subject is replaced with another, it is determined that the target subject image does not satisfy the first condition, even when, for example, the first subject has its body kept rotating within the imaging area.

In the above-mentioned first condition, the determination module 103 determines whether a person exists in the subject image within a predetermined distance from the display module 12, based on the coordinates of the joint position of the first subject in the target depth image. When the determination module 103 determines that, for example, a person exists as the first subject at a certain time, no person exists as the first subject at a subsequent time, and a person exists as the first subject at a further subsequent time, it determines that the first subject (person) existing in the imaging area has been replaced with another. In this case, the determination module 103 determines that the target subject image satisfies the first condition.

For instance, when the first subject positioned in front of the display module 12 and performing trial fitting has been switched to another, it is desirable that the first and second positions be newly calculated. By thus setting a state, where the first subject existing in the imaging area is switched to another first subject, as a condition for determination by the determination module 103, the accuracy of detection of the superposed position can be enhanced.

When the first position is calculated from a subject image obtained while the first subject in front of the display module 12 is moving, the calculation accuracy of the first position may be degraded. In view of this, it is preferable that the determination module 103 should determine that a subject image obtained a predetermined time after the first subject existing in the imaging area is switched to another first subject, and obtained after a stationary state of the latter first subject is detected, is a subject image satisfying the first condition. Various techniques can be used for detecting movement of the first subject (person), the stationary state of the first subject, etc.

Although in the embodiment, the first condition is that the first subject existing in the imaging area is switched from one to another, another condition is used as the first condition. Another condition used as the first condition will be briefly described.

Another first condition may be that clothing ID corresponding to clothing different from clothing included in a currently displayed composite image is designated as clothing ID corresponding to trial fitting clothing, by a user instruction through the input module 14.

In this case, the determination module 103 determines whether the target subject image is a subject image acquired immediately after new clothing ID is designated by a user instruction through the input module 14. Namely, when determining that the target subject image is a subject image acquired immediately after new clothing ID is designated, the determination module 103 determines that the target subject image satisfies the first condition.

When the first position is calculated from a subject image obtained while the first subject for trial fitting positioned in front of the display module 12 is moving to operate the input module 14, the calculation accuracy of the first position may be degraded. In view of this, it is preferable that the determination module 103 should determine that a subject image obtained a predetermined time after the user instruction through the input module 14 has been made, and obtained after a stationary state of the first subject (person) is detected, is a subject image satisfying the first condition.

Yet another first condition may be that the target subject image is a subject image obtained after a predetermined number of subject images are obtained from a preceding determination where the target subject image is determined to be a subject image for calculating the first position.

In this case, the determination module 103 determines whether the target subject image is a subject image obtained after the predetermined number of subject images are obtained from the preceding determination where the target subject image is determined to be a subject image for calculating the first position. Namely, when determining that the target subject image is a subject image obtained after the predetermined number of subject images are obtained, the determination module 103 determines that this target subject image satisfies the first condition.

As the predetermined number of subject images, 15 images (in the case of a video image, 15 frames), for example, may be set. However, the predetermined number is not limited to it. Further, it may be set such that the higher the processing load of the position calculator 109, the greater the number of subject images. Alternatively, the greater the movement of the first subject, the higher the number. Yet alternatively, these setting conditions may be combined.

The determination module 103 may determine whether the target subject image is a subject image obtained a predetermined period after the acquisition of a subject image determined, in a preceding determination, to be an output target for calculating the first position. Namely, when determining that the target subject image is a subject image obtained after the predetermined period elapses, the determination module 103 determines that the target subject image satisfies the first condition.

Also in this case, the determination module 103 should set the above-mentioned time in accordance with the processing load of the position calculator 109, the moving amount of the first subject, etc.

As yet another first condition, a condition that predetermined posture data coincides with the posture data (skeletal frame data generated by the skeletal frame data generator 102) of the first subject may be set. The predetermined posture data includes, for example, posture data indicating a posture of a person directly facing the front side and having arms opened through about 10 degrees.

In this case, the determination module 103 determines whether skeletal frame data (skeletal frame data of the first subject) generated by the skeletal frame data generator 102 based on the target subject image coincides with skeletal frame data included in, for example, predetermined posture data stored in the storage 16. That is, when determining that the skeletal frame data of the first subject coincides with the skeletal frame data included in the predetermined posture data, the determination module 103 determines that the target subject image satisfies the first condition.

There is a case where when the posture of the first subject does not coincide with the predetermined posture, the position calculator 109 hardly realizes sufficiently accurate template matching.

In view of this, it is preferable that when the predetermined posture data coincides with the posture data of the first subject, the determination module 103 determines that the target subject image satisfies the first condition.

As another first condition, a condition that the moving amount of the first subject is not more than a predetermined value may be set.

In this case, the determination module 103 determines the position of the first subject in a target subject image from the coordinates of a joint position of the first subject in a target depth image. The moving amount of the first subject is calculated by comparing the position of the first subject in a depth image acquired last time (i.e., in a preceding determination) with the position of the first subject in a depth image (i.e., the target depth image) acquired this time (i.e., in a current determination), these positions being determined by the determination module 103. When determining that the thus-calculated moving amount of the first subject is not more than a preset value, the determination module 103 determines that the target subject image satisfies the first condition.

As a further first condition, a condition that the first subject in the target subject image has its arms kept down may be set.

In this case, the determination module 103 determines whether portions of the target subject image corresponding to the arms of the first subject extend along the line from the shoulders of the first subject to the legs of the same (i.e., the first subject is in a state where its arms are kept down), based on the coordinates of the corresponding joint position of the first subject in the target depth image. When determining that the first subject is in the state where its arms are kept down, the determination module 103 determines that the target subject image satisfies the first condition.

When the first subject is in the state where its arms are kept up, it is strongly possible that the posture data of an output-target clothing image differs from that of the first subject image. When the position calculator 109 executes template matching, using a subject image of the first subject showing the above posture, the accurate of the template matching may be degraded. In view of this, it is preferable that when determining that the first subject is in the state where its arms are kept down, the determination module 103 should determine that the target subject image satisfies the first condition.

The first condition may be one of the above-described first conditions, or may be a combination of the conditions.

When it is determined in step S3 that the target subject image satisfies the first condition (YES in step S3), first clothing-image selection processing is performed (step S4). In the first clothing-image selection processing, the selection module 107 selects a clothing image as an output target. Also, in the first clothing-image selection processing, the adjustment module 108 executes adjustment processing on the output-target clothing image (hereinafter, referred to as target clothing images) selected by the selection module 107 and the target subject image. In the adjustment processing, for example, feature areas are extracted from the target clothing image and the target subject image used for the first clothing-image selection processing. Details of the first clothing-image selection processing will be described later.

Subsequently, the position calculator 109 performs first-position calculation processing (step S5). In the first-position calculation processing, the first position (i.e., the first portion of the subject clothing image) on a target subject image, where the position of the feature area of a target clothing image and the position of the feature area of the target subject image coincide each other, is calculated. Details of the first-position calculation processing will be described later.

The first position calculated by the first-position calculation processing is stored in the storage 16 in association with data that enables the target subject image to be specified (step S6). As the data that enables the target subject image to be specified, the acquisition time and date of the target subject image, for example, is used.

Subsequently, the position calculator 109 executes second-position calculation processing (step S7). In the second-position calculation processing, the second position (i.e., the second portion of the target clothing image) on a target subject image, where the position of the feature point of the target clothing image and the position of the feature point of the target subject image coincide with each other, is calculated. Details of the second-position calculation processing will be described later.

The second position calculated by the second-position calculation processing is stored in the storage 16 in association with data that enables the target subject image to be specified (step S8). As the data that enables the target subject image to be specified, data similar to, for example, that used in step S6 is used.

Subsequently, the decision module 110 reads, from the storage 16, the first position calculated in step S5 and the second position calculated in step S7. The decision module 110 calculates the difference between the read first and second positions (step S9).

The difference calculated by the decision module 110 is stored in the storage 16 in association with the data, used in steps S6 and S8, which enables the target subject image to be specified (step S10).

When the difference between the first and second positions is already stored in the storage 16, it may be overwritten by the difference calculated in step S9 so that only a newest difference will be stored in the storage 16.

Subsequently, the decision module 110 decides a superposed position (step S11). In this case, the decision module 110 decides the first position calculated in step S5 as the superposed position (i.e., the superposed portion of the target clothing image) on the target subject image.

Namely, in the processing of the above-mentioned steps S3 to S11, when the target subject image satisfies the first condition, the first position calculated by the position calculator 109 is decided as the superposed position (i.e., the superposed portion of the target clothing images) on the target subject image.

In contrast, when it is determined in step S3 that the target subject image does not satisfy the first condition in step S3 (NO in step S3), the second clothing-image selection processing is performed (step S12). In the second clothing-image selection processing, an output-target clothing image is selected by the selection module 107 as a result of performing processing different from the above-described first clothing-image selection processing. In accordance with operation modes set in the image processing system 10 (image processing apparatus 100), different processing procedures are employed for selecting the output-target clothing image.

More specifically, when, for example, the above-described tracking mode is set as an operation mode in the image processing system 10, a clothing image, which is included in the clothing images in the first data stored in the storage 16 and corresponds to the rotational angle of the first subject that indicates the orientation of the first subject and is calculated by the posture data calculator 106, is selected as an output-target clothing image in the second clothing-image selection processing.

Further, when, for example, the above-described full-length mirror mode is set as an operation mode in the image processing system 10, a clothing image, which is included in the clothing images in the first data stored in the storage 16 and corresponds to a rotational angle other than the rotational angle of the first subject calculated by the posture data calculator 106, is selected as an output-target clothing image in the second clothing-image selection processing.

Furthermore, in the second clothing-image selection processing, the adjustment module 108 executes adjustment processing on the output-target clothing image (target clothing image) selected by the selection module 107 and the target subject image, as in the first clothing-image selection processing. Details of the second clothing-image selection processing will be described later.

Subsequently, the position calculator 109 performs the second-position calculation processing (step S13). The second-position calculation processing performed in step S13 is the same as the second-position calculation processing performed in the above-mentioned step S7.

The decision module 110 decides a superposed position, based on a second position calculated by the second-position calculation processing in step S13 (step S14).

More specifically, the decision module 110 reads, from the storage 16, the difference between a first position calculated based on a subject image acquired before a currently acquired subject image (i.e., a target subject image), and a second position calculated from the subject image used for the first-position calculation. When a plurality of previously calculated differences are stored in the storage 16, the decision module 110 reads a newest difference (namely, a difference calculated last time) from the plurality of differences. The decision module 110 decides, as a superposed position, a position obtained by shifting, by the read difference, the second position calculated by the second-position calculation processing in step S13.

The direction in which the second position is shifted is parallel to a vector that uses, as an origin, the second position stored in the storage 16 (i.e., the second position calculated last time by the position calculator 109), and uses, as an end point, the first position stored in the storage 16 (i.e., the first position calculated last time by the position calculator 109).

When the above-mentioned step S11 or S14 is executed, the composite image generator 111 generates a composite image (step S15). In this case, the composite image generator 111 generates a composite image by superposing a target clothing image in the superposed position (decided by the decision module 110) on the target subject image.

When a composite image has been generated by the composite image generator 111 as described above, the display controller 112 performs control for presenting the composite image to a user (for example, the first subject). Namely, the composite image generated by the composite image generator 111 is displayed, for example, on the display module 12 (step S16).

Subsequently, in the image processing apparatus 100, it is determined whether image processing is ended (step S17). Assume here that the image processing apparatus 100 is provided with an end indicating button (not shown) for instructing end of image processing in the image processing apparatus 100. When the end indicating button is designated by the user, the image processing apparatus 100 accepts a signal (hereinafter, referred to as an end indicating signal) that indicates end of image processing in the image processing apparatus 100. Namely, when the end indicating signal is received by the image processing apparatus 100, it is determined that image processing should be ended.

Thus, when it is determined that image processing should be ended (YES in step S17), image processing in the image processing apparatus 100 is ended.

In contrast, it is determined that image processing should not be ended (NO in step S17), the program returns to step S1, thereby repeating the above processing.

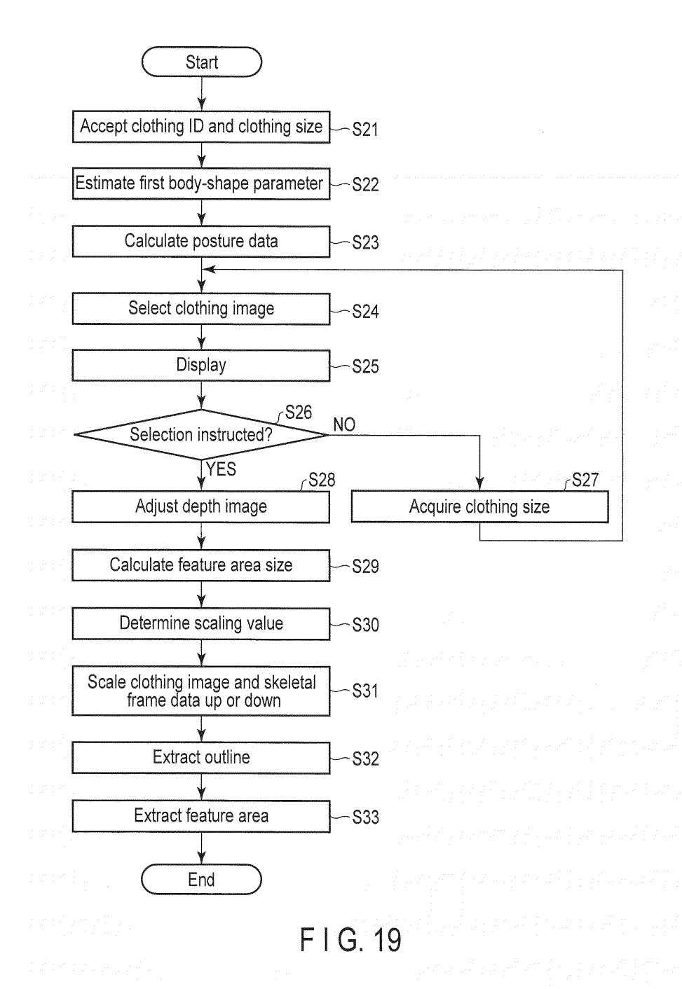

Referring then to the flowchart of FIG. 19, a description will be given of a procedure of the above-mentioned first clothing-images selection processing (processing of step S4 in FIG. 18).

Firstly, the acceptance module 104 accepts the clothing ID and a clothing size of clothing for trial fitting through the input module 14 (step S21).

The processing of step S21 for accepting the clothing ID and clothing size may be performed before, for example, the above-described processing of FIG. 18.

Subsequently, the body-shape parameter acquisition module 105 estimates the first body-shape parameter of the first subject from a target depth image (a depth image acquired by depth image acquisition module 101b in step S1 of FIG. 18) (step S22). Thus, the body-shape parameter acquisition module 105 acquires the estimated first body-shape parameter of the first subject.

When the body-shape parameter acquisition module 105 has acquired a weight from the weight measuring module 13, the module 105 acquires a first body-shape parameter including parameter components estimated from the acquired weight and target depth image.

Subsequently, the posture data calculator 106 calculates the posture data of the first subject, based on the skeletal frame data of the first subject generated by the skeletal frame data generator 102 (step S23). In this case, the posture data calculator 106 calculates the orientation (angle) of the first subject from the position of each joint indicated by the skeletal frame data of the first subject. The orientation of the first subject is indicated by the rotational angle of the first subject with respect to the reference orientation (angle) of the same when the face and body of the first subject are completely aligned with the optical axis of first imaging module 15A. Thus, the posture data calculator 106 calculates posture data including the orientation data (and skeletal frame data) of the first subject. It is supposed that the posture data calculated by the posture data calculator 106 is stored in the storage 16 in association with, for example, data that enables a target subject image to be specified. As the data that enables the target subject image to be specified, data similar to that used in, for example, step S6 of FIG. 18 can be used.

Subsequently, the selection module 107 selects a clothing image of a plurality of clothing images in the first data stored in the storage 16 (step S24). The clothing image selected by the selection module 107 is a clothing image corresponding to the clothing ID and clothing size accepted by the acceptance module 104, corresponding to second body-shape parameters having degrees of dissimilarity estimated by the body-shape parameter acquisition module 105 lower than a threshold with respect to the first body-shape parameter, and also corresponding to posture data (i.e., the rotational angle of the first subject) calculated by the posture data calculator 106.

The display controller 112 displays the clothing image selected (read) by the selection module 107 on the display module 12 (step S25).

At this time, it is determined whether a user selection instruction for a clothing image through the input module 14 has been accepted by the acceptance module 104 (step S26).

When no selection instruction has been accepted (NO in step S26), the acceptance module 104 acquires another clothing size different from that accepted in step S21 through the input module 14, in accordance with another user instruction through the input module 14 (step S27). After step S27 is executed, the program returns to step S24, where the above processing is repeated. Thus, step S24 and subsequent steps are repeated, with the clothing size acquired in step S21 changed to that acquired in step S27.

Although in the embodiment, another clothing size is acquired in step S27, another clothing ID and another clothing size may be acquired, instead, in step S27. In this case, step S24 and subsequent steps are repeated, with the clothing ID and the clothing size acquired in step S21 changed to those acquired in step S27.

In contrast, when the selection instruction has been accepted (YES in step S26), the resultant selected clothing image is selected as an output-target clothing image. Namely, in the first clothing-image selection processing, a clothing image as an output target is selected by executing the above-described steps S21 to S27. The output-target clothing image selected by the first clothing-image selection processing is a clothing image corresponding to the posture data (indicating the rotational angle of the first subject) calculated by the posture data calculator 106, namely, a clothing image for indicating a state where the clothing is fitted on the body of the first subject. The clothing ID for identifying the output-target clothing image selected in the first clothing-image selection processing (in steps S21 to S27) and clothing size (i.e., the clothing ID and clothing size designated by the user) are stored in the storage 16. Hereafter, the clothing ID and clothing size stored in the storage 16 will be referred to as designated clothing ID and designated clothing size for convenience.

Subsequently, the adjustment module 108 adjusts a target depth image (step S28). More specifically, the adjustment module 108 transforms the coordinate system (i.e., the coordinate system of second imaging module 15B) of the position of each pixel of the target depth image into the coordinate system of first imaging module 15A. The adjustment module 108 executes projection so that the position of each pixel constituting the target depth image, assumed after the coordinate transform, will correspond to the position of each pixel constituting a target subject image (i.e., the subject image acquired by subject-image acquisition module 101a in step S1 of FIG. 18) acquired at the same time. Thereby, the adjustment module 108 adjusts the target depth image to the same resolution as the target subject image.

Subsequently, the adjustment module 108 calculates the size of the feature area of the target clothing image (i.e., the output-target clothing image selected by executing steps S21 to S27), and the size of the feature area of the target subject image (step S29). In the embodiment, the shoulder area is used as the feature area. For this reason, the adjustment module 108 calculates the shoulder measurement of the target clothing image and the shoulder measurement of the target subject image as the sizes of the feature areas.

The adjustment module 108 determines the scaling ratio of the target clothing image from the calculated sizes of the feature areas, i.e., the shoulder measurement of the target clothing image and the shoulder measurement of the target subject image (step S30).

The adjustment module 108 scales up or down the target clothing image and skeletal frame data included in posture data corresponding to the target clothing image, using the determined scaling ratio (step S31).

Subsequently, the adjustment module 108 extracts respective feature areas from the scaled-up or scaled-down target clothing image and the target subject image.

In this case, the adjustment module 108 extracts the respective outlines of the scaled-up or scaled-down target clothing image and the target subject image (step S32).

Subsequently, the adjustment module 108 extracts the shoulder areas of the respective extracted outlines of the target clothing image and the target subject image, as their feature areas (step S33). The execution of step S33 is the end of the first clothing-image selection processing.

Although the target clothing image is scaled up or down in the above-mentioned step S31, using the scaling ratio determined from the sizes of the feature areas (shoulder measurements) of the target clothing image and the target subject image, it is sufficient if, for example, at least the target clothing image or the target subject image is scaled up or down so that at least portions of the outlines of the target clothing image and the target subject image coincide with each other. Accordingly, the target subject image may be scaled up or down, using the inverse of the scaling ratio determined in step S30.

As described above, in the first clothing-image selection processing, the target clothing image or the target subject image is scaled up or down by executing steps S28 to S33, then a shoulder area is extracted as the feature area from the target clothing images and target subject image.

The feature areas of clothing images may be beforehand associated with the clothing images themselves in, for example, the first data. In this case, it is sufficient if the adjustment module 108 beforehand executes steps S32 and S33 for each of the clothing images. In the first clothing-image selection processing constructed like this, a feature area used in first-position calculation processing executed later can be obtained by scaling up or down the feature area of a clothing image selected as an output-target clothing image, based on the scaling ratio determined in step S30.

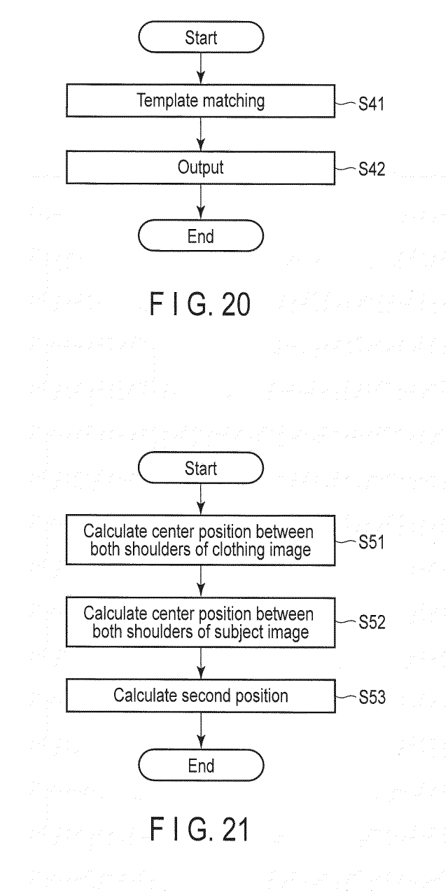

Referring then to the flowchart of FIG. 20, the procedure of the aforementioned first-position calculation processing (processing of step S5 shown in FIG. 18) will be described.

Firstly, the position calculator 109 performs template matching, using the shoulder areas of the target clothing image and the target subject image extracted as feature areas by the adjustment module 108 (step S41). At this time, the position calculator 109 searches for a target depth image adjusted by the adjustment module 108 by template matching, and calculates, as the first position, a position on the target depth image (target subject image), which corresponds to the feature area (shoulder area) of the target clothing image.

Subsequently, the position calculator 109 outputs the calculated first position to the decision module 110 (step S42).

The execution of step S42 is the end of the first-position calculation processing. As mentioned above, the first position calculated by the position calculator 109 is stored in the storage 16.

Referring to the flowchart of FIG. 21, the aforementioned second-position calculation processing (i.e., processing in steps S7 and S13 shown in FIG. 18) will be described.

Firstly, the position calculator 109 calculates the position of the feature point of the target clothing image determined from the feature area of the same. Assuming here that the feature area of the target clothing image is a shoulder area as mentioned above, the position calculator 109 calculates the center position between both shoulders of (clothing worn by) a second subject in the target clothing image as the feature point of the target clothing image (step S51). In this case, the position calculator 109 calculates the center position between both shoulders of the second subject, for example, from the skeletal frame data (data on a skeletal frame scaled up or down in the above-described first clothing-image selection processing) included in posture data corresponding to the target clothing image.

Similarly, the position calculator 109 calculates the position of the feature point of the target subject image determined in accordance with the feature area of the target subject image. Assuming here that the feature area of the target subject image is the shoulder area as mentioned above, the position calculator 109 calculates the center position between both shoulders of the first subject in the target subject image as the feature point of the target subject image (step S52). In this case, the position calculator 109 calculates the center position between both shoulders of the first subject from the skeletal frame data of the first subject generated by the skeletal frame data generator 102 in step S2 of FIG. 18.

Subsequently, the position calculator 109 calculates a second position so that the center position calculated in step S51 will coincide with the center position calculated in step S52 (step S53). In the embodiment, the position calculator 109 calculates, as the second position, the center position between both shoulders of the first subject in the target subject image calculated in step S52.

The execution of step S53 is the end of the second-position calculation processing. The second position calculated by the position calculator 109 is stored in the storage 16 as described above.

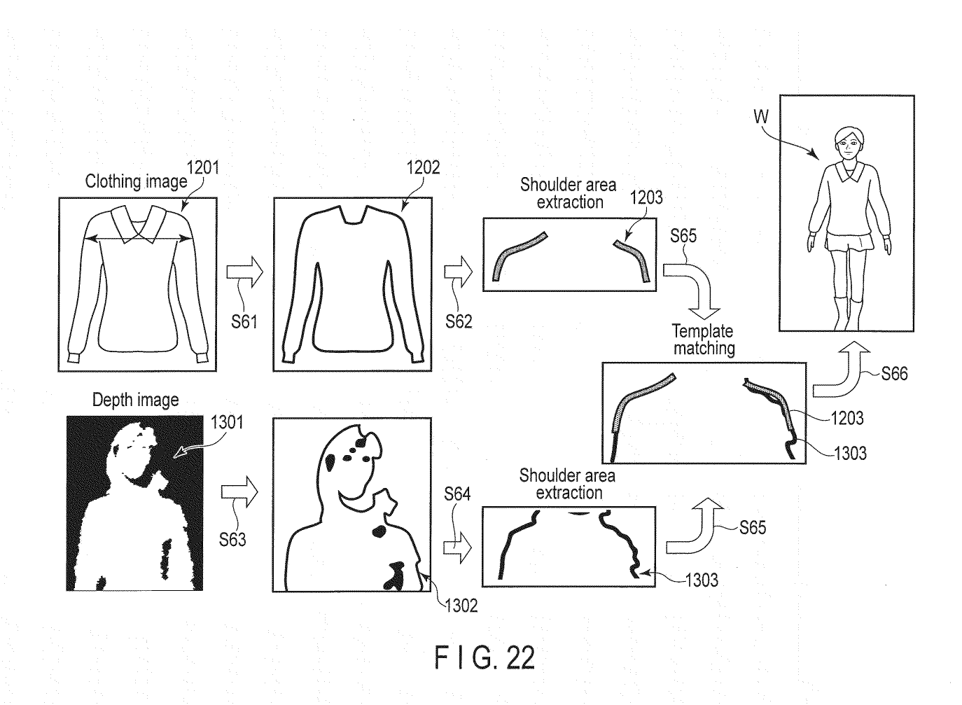

Referring then to FIG. 22, a description will be given of generation of a composite image executed when it is determined in step S3 of FIG. 18 that the first condition is satisfied.

Assume here that an output-target clothing image (target clothing image) is a clothing image 1201 shown in FIG. 22, and a depth image (target depth image) of the first subject is a depth image 1301 shown in FIG. 22.

In this case, as shown in FIG. 22, the adjustment module 108 extracts an outline 1202 from the clothing image 1201 by adjustment processing (step S61). Further, the adjustment module 108 extracts a shoulder area 1203 as the feature area by the adjustment processing (step S62).

Similarly, as shown in FIG. 22, the adjustment module 108 extracts an outline 1302 from the depth image 1301 by adjustment processing (step S63). Further, the adjustment module 108 extracts a shoulder area 1303 as the feature area by the adjustment processing (step S64).

Subsequently, template matching using the shoulder area 1203 of the clothing image and the shoulder area 1303 of the depth image (subject image) is performed (step S65). As a result, the above-mentioned first position is obtained. At this time, the first position is determined as a superposed position.

In this case, the clothing image 1201 is superposed in the superposed position (the first position) on the subject image (target subject image) of the first subject is overlapped on the clothing images 1201. Thus, a composite image W is generated (step S66).

Namely, when it is determined in step S3 shown in FIG. 18 that the first condition is satisfied, the composite image W showing a state in which clothing is fitted on the body of the first subject is presented (displayed) to the user.

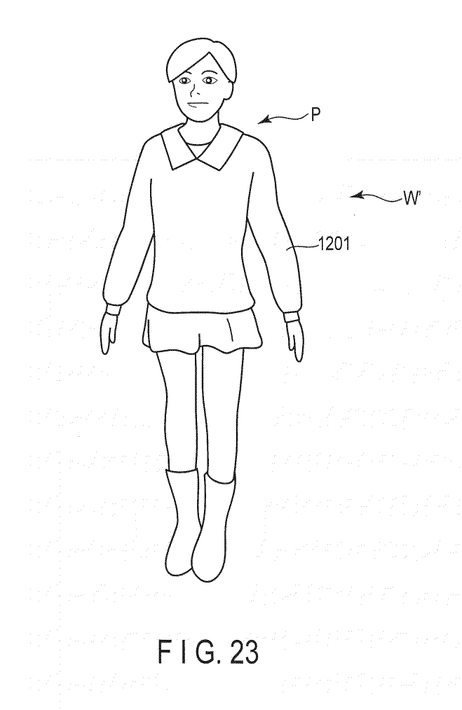

FIG. 23 shows an example of the composite image W. As mentioned above, the composite image W is an image obtained by superposing the clothing image 1201 upon (a first subject P included in) the subject image. The clothing image 1201 is a clothing image showing a state in which a second subject of a body shape similar to the body shape of the first subject is wearing clothing identified by clothing ID accepted by the acceptance module 104. Thus, in the embodiment, a composite image W showing a trial fitting state corresponding to the body shape of the first subject is presented to the user, as is shown in FIG. 23.

Subsequently, the above-described second clothing-image selection processing (processing of step S12 in FIG. 18) will be described. As described above, the procedure of the second clothing-image selection processing differs in accordance with an operation mode set in the image processing system 10. A description will be given of each of a case where a tracking mode is set as the operation mode of the image processing system 10, and a case where a full-length mirror mode is set as the operation mode. Further, a case is supposed where the user has rotated their body within the imaging area after the above-described first clothing-image selection processing is performed.

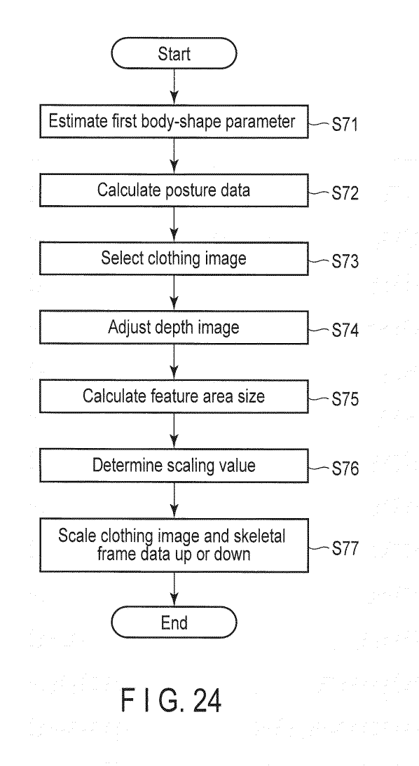

Referring first to the flowchart of FIG. 24, a description will be given of the second clothing-image selection processing executed in the case where the tracking mode is set as the operation mode of the image processing system 10.

In the second clothing-image selection processing executed in the case where the tracking mode is set, steps S71 and S72 equivalent to steps S22 and S23 shown in FIG. 19 are executed.

Subsequently, the selection module 107 selects, as a target clothing image, a clothing image of a plurality of clothing images corresponding to the clothing ID and the clothing size (i.e., the designated clothing ID and the designated clothing size) accepted by the acceptance module 104 in previously executed first clothing-image selection processing, the clothing image being in the first data in the storage 16 (step S73). The clothing image selected in step S73 is a clothing image corresponding to a second-body parameter, the degree of dissimilarity of which second-body parameter with respect to the first-body parameter acquired (estimated) in step S71 are not more than a threshold, and also corresponding to posture data (indicating the rotational angle of the first subject) calculated in step S72.

Steps that are equivalent to the above-mentioned steps S28 to S31 of FIG. 19 but are not shown in FIG. 24 may be further executed to change, for example, the designated clothing size.

Subsequently, steps S74 to S77 equivalent to the above-mentioned steps S28 to S31 of FIG. 19 are executed, thereby ending the second clothing-image selection processing.

Skeletal frame data scaled up or down in step S77 is used in second-position calculation processing performed after the second clothing-image selection processing. Since the second-position calculation processing is similar to that described with reference to FIG. 21, no detailed description is given thereof.

Where the first subject has rotated its body within the imaging area with the tracking mode set in the image processing system 10 as described above, after, for example, the first clothing-image selection processing is executed, a clothing image (for indicating a state in which clothing is fitted on the body of the user) corresponding to the rotational angle of the rotated first subject is selected by executing the second clothing-image selection processing shown in FIG. 24.

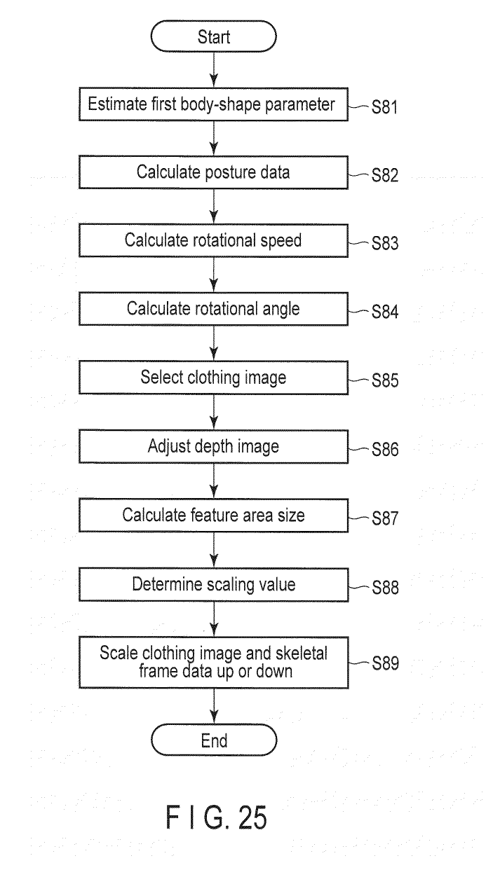

Referring then to the flowchart of FIG. 25, a description will be given of the procedure of the second clothing-image selection processing in the case where the full-length mirror mode is set as the operation mode of the image processing system 10.

In the second clothing-image selection processing executed in the case where the full-length mirror mode is set, steps S81 and S82 equivalent to steps S21 and S22 (steps S71 and S72 shown in FIG. 24) shown in FIG. 19 are executed.

Subsequently, the selection module 107 calculates the rotational speed of the first subject, based on posture data calculated this time (i.e., posture data calculated in step S82), and posture data calculated last time (i.e., posture data stored in the storage 16 in the first or second clothing-image selection processing of the last loop) (step S83).

In this case, the selection module 107 calculates the rotational speed of the first subject, based on an amount of change between the rotational angle (first rotational angle) of the first subject included in the posture data calculated this time, and the rotational angle (third rotational angle) of the first subject included in the posture data calculated last time.

The rotational angle of the first subject included in the posture data calculated last time (hereinafter, referred to as the previous rotational angle) is calculated based on, for example, a subject image acquired in the previous processing shown in FIG. 18 (i.e., a subject image acquired before a subject image acquired in the current processing shown in FIG. 18). In contrast, the rotational angle of the first subject included in the posture data calculated this time (hereinafter, referred to as the current rotational angle) is calculated based on, for example, a subject image acquired in the current processing shown in FIG. 18.

In this case, the selection module 107 calculates the rotational speed of the first subject by, for example, dividing the difference between the current and previous rotational angles by the interval of acquisition of the subject images (i.e., the interval at which the first subject are imaged by the imaging module).

Subsequently, the selection module 107 calculates a rotational angle (second rotational angle) different from the current rotational angle, based on the current rotational angle and the calculated rotational speed (step S84). The rotational angle calculated in step S84 is used to select an output-target clothing image, described later. The rotational angle calculated in step S84 will be referred to as a full-length-mirror-mode rotational angle, for convenience.

The calculation processing in step S84 will be described in detail. Specifically, a description will be given of a case where a rotational angle greater than the current rotational angle is calculated as the full-length-mirror-mode rotational angle.

In this case, the selection module 107 calculates an angle (hereinafter, referred to as the reference angle) that is uniquely determined from the current rotational angle (i.e., the actual orientation of the first subject), and is at least not less than the current rotational angle. This reference angle can be calculated using a sigmoid function. However, other functions may be used.

Subsequently, the selection module 107 determines an offset value corresponding to the calculated rotational speed, based on, for example, a predetermined function. For instance, the greater the calculated rotational speed, the greater the offset value. The selection module 107 calculates the full-length-mirror-mode rotational angle by adding the determined offset value to the reference angle.

The selection module 107 can compute a full-length-mirror-mode rotational angle greater than the current rotational angle by executing the above processing.

When having calculated the full-length-mirror-mode rotational angle in step S84, the selection module 107 selects, as an output-target clothing image, a clothing image of a plurality of clothing images corresponding to the clothing ID and the clothing size (i.e., the designated clothing ID and the designated clothing size in the storage 16) accepted by the acceptance module 104 in previously executed first clothing-image selection processing, the clothing image being in the first data in the storage 16 (step S85). The clothing image selected in step S73 is a clothing image corresponding to a second-body parameter, the degree of dissimilarity of which second-body parameter with respect to the first-body parameter acquired (estimated) in step S81 are not more than a threshold, and also corresponding to the full-length-mirror-mode rotational angle calculated (estimated) in step S84.

The designated clothing size, for example, may be changed by further executing processing equivalent to the aforementioned steps S25 to S27 of FIG. 19, although these steps are omitted in FIG. 25.

Subsequently, steps S86 to S89 equivalent to the aforementioned steps S28 to S31 of FIG. 19 (or steps S74 to S77 of FIG. 24) are executed, thereby ending the second clothing-image selection processing.

The skeletal frame data scaled up or down in step S89 is used in the second-position calculation processing performed after the second clothing-image selection processing. Since the second-position calculation processing is already described with reference to FIG. 21, no detailed described is given thereof.

Where the first subject has rotated its body within the imaging area with the full-length mirror mode set in the image processing system 10 as described above, after, for example, the first clothing-image selection processing is executed, a clothing image corresponding to the rotational angle for the full-length mirror mode greater than the rotational angle of the rotated first subject (i.e., a clothing image for indicating a state of clothing further rotated than the actual rotation of the first subject) is selected by executing the second clothing-image selection processing shown in FIG. 25.

In the second clothing-image selection processing shown in FIG. 25, it is supposed that the rotational speed of the first subject is calculated in step S83, and the rotational angle for the full-length mirror mode is calculated based on the current rotational angle of the first subject and the calculated rotational speed. However, step S83 may be omitted to calculate the rotational angle for the full-length mirror mode based on the current rotational angle only. In this case, it is sufficient if the aforementioned reference angle calculated using, for example, the sigmoid function is used as the rotational angle for the full-length mirror mode. In the calculation of the rotational angle for the full-length mirror mode, it can be arbitrarily set whether the rotational speed (i.e., the offset value) is utilized.

Moreover, although in the embodiment, a rotational angle for the full-length mirror mode greater than the current rotational angle is calculated, this can be modified such that if, for example, the current rotational angle exceeds a predetermined angle, the predetermined rotational angle is calculated as the rotational angle for the full-length mirror mode. In this case, it is supposed that the rotational angle calculated as the rotational angle for the full-length mirror mode can be arbitrarily set to an angle desired by the user.

A description will be given of a composite image presented when it is determined in the aforementioned step S3 of FIG. 18 that the first condition is not satisfied and the tracking mode is set in the image processing system 10, and a composite image presented when the full-length mirror mode is set. In this case, it is supposed that the first subject P has rotated clockwise after the composite image W shown in FIG. 23 is presented.

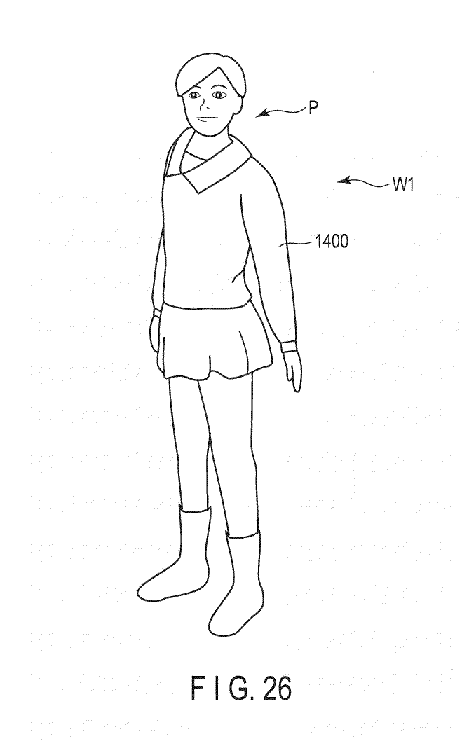

FIG. 26 shows an example of composite image W1 presented in the case where the tracking mode is set. Composite image W1 of FIG. 26 shows a clothing image 1400 superposed upon a subject image wherein the body of the first subject P is clockwise rotated through about 80 degrees.

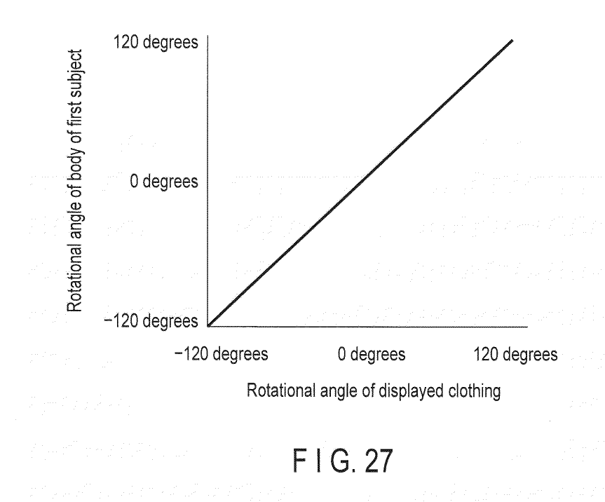

FIG. 27 shows an example of a correspondence relationship between the rotational angle of the first subject P in the subject image and the rotational angle corresponding to a clothing image superposed upon the subject image (i.e., the rotational angle of the displayed clothing) in the case where the tracking mode is set. As shown in FIG. 27, when the tracking mode is set in the embodiment, the rotational angle of the displayed clothing coincides with that of the body of the first subject P.

As a result, in the embodiment, when the first subject P rotates its body in the tracking mode, composite image W1 showing a state where clothing is fitted on the body of the first subject P as shown in FIG. 26 (i.e., the rotational angle of the clothing coincides with that of the body of the first subject P) can be presented.

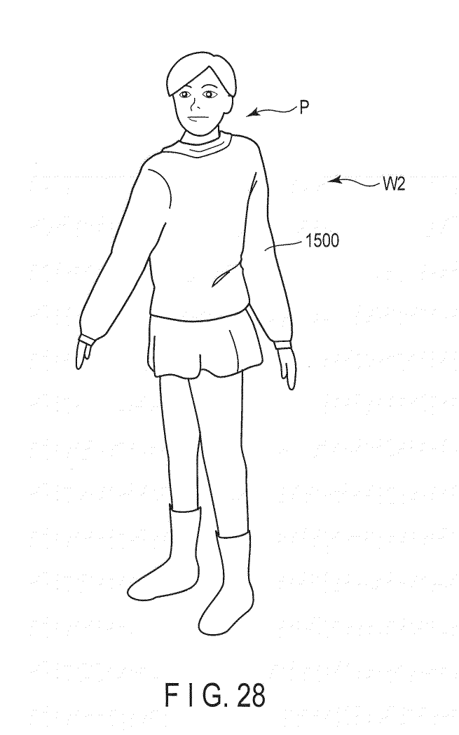

In contrast, FIG. 28 shows an example of composite image W2 presented in the case where the full-length mirror mode is set. As in the case of FIG. 26, composite image W2 of FIG. 28 shows a clothing image 1500 superposed upon a subject image wherein the body of the first subject P is clockwise rotated through about 80 degrees.

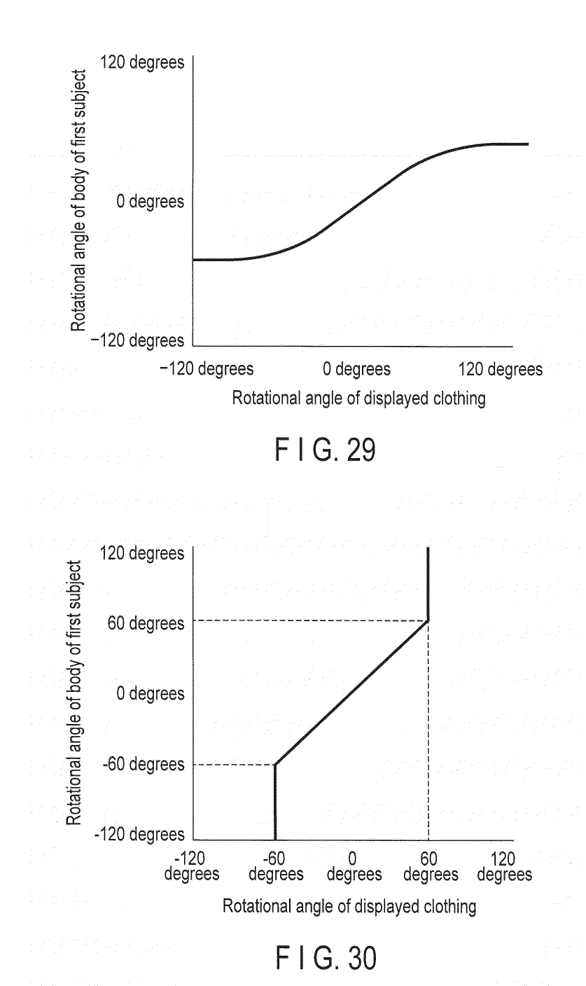

FIG. 29 shows an example of a correspondence relationship between the rotational angle of the first subject P in the subject image and the rotational angle corresponding to a clothing image superposed upon the subject image (i.e., the rotational angle of the displayed clothing) in the case where the full-length mirror mode is set. The rotational angle of the displayed clothing shown in FIG. 29 is a rotational angle for the full-length mirror mode calculated from a corresponding rotational angle of the first subject P. In FIG. 29, the reference angle calculated from the rotational angle of the first subject P, using, for example, the sigmoid function is used as the rotational angle for the full-length mirror mode for convenience sake. In this case, as shown in FIG. 29, the rotational angle of the displayed clothing is set at least not less than the rotational angle of the first subject P. Alternatively, a value obtained by adding the above-mentioned offset value to the rotational angle of the displayed clothing shown in FIG. 29 may be used as the rotational angle for the full-length mirror mode.

By virtue of the above structure, when in the embodiment, the first subject P rotates its body in a state where the full-length mirror mode is set, composite image W2 roughly showing the back shot, for example, of the first subject P wearing clothing can be presented as shown in FIG. 28, although the clothing does not fit the body of the first subject P, compared to the case of the tracking mode.

Although FIG. 29 shows the rotational angle (reference angle) for the full-length mirror mode calculated using the aforementioned sigmoid function, the structure may be modified such that a predetermined angle (second predetermined angle) may be used as the rotational angle for the full-length mirror mode (i.e., the rotational angle of the displayed clothing) when the rotational angle of the first subject P exceeds a predetermined angle (first predetermined angle), as is shown in, for example, FIGS. 30 and 31. FIG. 30 shows an example where when the body of the first subject P is at a rotational angle of not less than 60 degrees (or −60 degrees), the rotational angle of the displayed clothing is set to 60 degrees (or −60 degrees). FIG. 31 shows an example where when the body of the first subject P is at the rotational angle of not less than 60 degrees (or −60 degrees), the rotational angle of the displayed clothing is set to 80 degrees (or −80 degrees).

As described above, in the embodiment, the rotational angle for the full-length mirror mode, which differs from the rotational angle of the first subject, is calculated based on the rotational angle of the first subject and the rotational speed of the first subject. The clothing image corresponding to the rotational angle for the full-length mirror mode of a plurality of clothing images stored in the storage 16 is selected. The composite image in which the selected clothing image is superposed on a subject image is generated. In this case, the rotational angle for the full-length mirror mode is calculated by, for example, adding an offset value corresponding to the rotational speed of the first subject to the reference angle that is uniquely determined in accordance with the rotational angle of the first subject, the reference angle being at least not less than this rotational angle.

Namely, in the embodiment, by generating a composite image in which a clothing image corresponding to a rotational angle obtained by weighting the rotational angle of the body of the first subject in accordance with the rotational angle itself and the rotational speed is superposed, a clothing image of a large rotational angle can be displayed even when the actual rotational angle of the body of the first subject is small. In the embodiment, by virtue of this structure, the user (first subject) can easily check, for example, the back shot of virtually trial-fitted clothing, which enhances the usability.

When the first subject sees the display module 12 with the body rotated, the body may move to thereby change the rotational angle of the clothing displayed on the display module 12. Further, when the first subject rotates the body to check the clothing (image) at a desired angle, it is necessary to adjust the rotation (angle) of the body of the first subject so that the clothing will be displayed at a desired angle. In view of this, in the embodiment, when the rotational angle of the first subject exceeds a predetermined angle (e.g., 60 degrees), as is described above referring to FIG. 30, the rotational angle for the full-length mirror mode is set to the predetermined angle (e.g., 60 degrees). At this time, since a clothing image of a desired angle can be displayed without fine adjustment of the rotation (angle) of the first subject, which reduces the burden of the user during virtual trial fitting. Similarly, when, for example, the rotational angle of the first subject exceeds a predetermined angle (e.g., 60 degrees) as shown in FIG. 31, and the rotational angle for the full-length mirror mode is set to a predetermined angle (e.g., 80 degrees) greater then the first-mentioned predetermined angle, a clothing image of a desired angle can be displayed even when the first subject slightly rotates, which also reduces the burden of the user during virtual trial fitting.

Moreover, in the embodiment, when the tracking mode is set, a clothing image corresponding to the actual rotational angle of the first subject is selected as an output-target clothing image, while when the full-length mirror mode is set, a clothing image corresponding to the rotational angle for the full-length mirror mode is selected as an output-target clothing image. Furthermore, in the embodiment, it is possible to change the mode between the tracking mode and the full-length mirror mode in accordance with a user instruction. By virtue of this structure, in the embodiment, when the user wants to check a state in which, for example, clothing is fitted on the body of the first subject, the tracking mode is set, while when the user wants to check, for example, the mood of clothing, the full-length mirror mode is set. As a result, a composite image that comes up to the intention of the user can be presented.

Yet further, in the embodiment, clothing images, which show states where clothing items corresponding to one or more clothing sizes are worn by second subjects of body shapes substantially identical to or similar to the body shape of the first subject are selected as output-target clothing images, thereby generating composite images of the subject image of the first subject and the respective clothing images. Thus, the embodiment can provide trial fitting states corresponding to the body shape of the first subject.

The image processing apparatus 100 according to the embodiment may have a function of notifying the user (the first subject) of the operation mode (the tracking mode or the full-length mirror mode) set in, for example, the image processing system 10 (image processing apparatus 100). More specifically, a clothing image (as an output-target clothing image selected by the selection module 107) superposed on a subject image may be processed such that whether the tracking mode or the full-length mirror mode is set is notified when the composite image generator 111 generates a composite image. In this case, when the clothing image are processed in different ways in accordance with the set operation modes, the user can be notified of whether the tracking mode or the full-length mirror mode is set. The different ways of processing of the clothing image include, for example, an image effect applied to the outline of a clothing image, and animation applied to the clothing image. For instance, a currently-set operation mode may be notified by displaying, on a predetermined area of the display module 12, a character string, a mark, etc., indicating the currently-set operation mode.

Also, in the embodiment, when it is determined in the aforementioned step S3 of FIG. 18 that the first condition is not satisfied, second clothing-image selection processing according to the operation mode set in the image processing system 10 is performed. In contrast, when it is determined in step S3 of FIG. 18 that the first condition is satisfied, the first clothing-image selection processing shown in FIG. 19 is executed regardless of the set operation mode. However, also in the first clothing-image selection processing, different types of processing may be executed in accordance with different operation modes. More specifically, it can be constructed such that when the tracking mode is set, a clothing image corresponding to the actual rotational angle of the first subject is selected as an output-target clothing image in the first clothing-image selection processing as shown in FIG. 19, while when the full-length mirror mode is set, a clothing image corresponding to the above-mentioned rotational angle for the full-length mirror mode, calculated from, for example, the actual rotational angle of the first subject, is selected as an output-target clothing image in the first clothing-image selection processing.

Further, although the embodiment is directed to a case where the acceptance module 104 accepts one clothing ID as clothing ID for identifying clothing for trial fitting, it may accept a plurality of clothing IDs as the clothing ID for identifying clothing for trial fitting. For instance, when the first subject would like to try on a combination of clothing items, the acceptance module 104 can accept a plurality of clothing IDs in accordance with a user instruction through the input module 14. When a plurality of clothing IDs are accepted by the acceptance module 104, the above-mentioned processing is executed for each of the IDs.

In this case, the image processing apparatus 100 may execute the following processing: Namely, the selection module 107 selects a output-target clothing image corresponding to one of the clothing IDs accepted by the acceptance module 104. For other clothing IDs included in the accepted clothing IDs, the selection module 107 selects, as composing targets, clothing images that are included in clothing images corresponding to each of the mentioned other IDs, and correspond to the model ID of an already-selected clothing image.

In the first clothing-image selection processing shown in FIG. 19, it is supposed that the acceptance module 104 accepts clothing ID and a clothing size through the input module 14. However, the acceptance module 104 may accept only clothing ID through the input module 14, and no clothing size through the same.

In this case, it is sufficient if the selection module 107 selects clothing images corresponding to second body-shape parameters having degrees of dissimilarity not more than a threshold with respect to the first body-shape parameter, for each of all clothing sizes corresponding to the clothing ID.

The scope of application of the image processing apparatus 100 according to the embodiment is not limited. Namely, the image processing apparatus 100 may be installed in the equipment located in, for example, a store, or in an electronic apparatus, such as a personal digital assistant, a personal computer (PC), or a television receiver. Moreover, the image processing apparatus 100 may be applied to an electronic blackboard system (signage system). When the image processing apparatus 100 is installed in, for example, equipment located in a store, the image processing system 10 including the image processing apparatus 100 should just be realized as shown in, for example, FIG. 1. On the other hand, when the image processing apparatus 100 is incorporated in an electronic apparatus, it should just be realized as shown in, for example, FIG. 2.

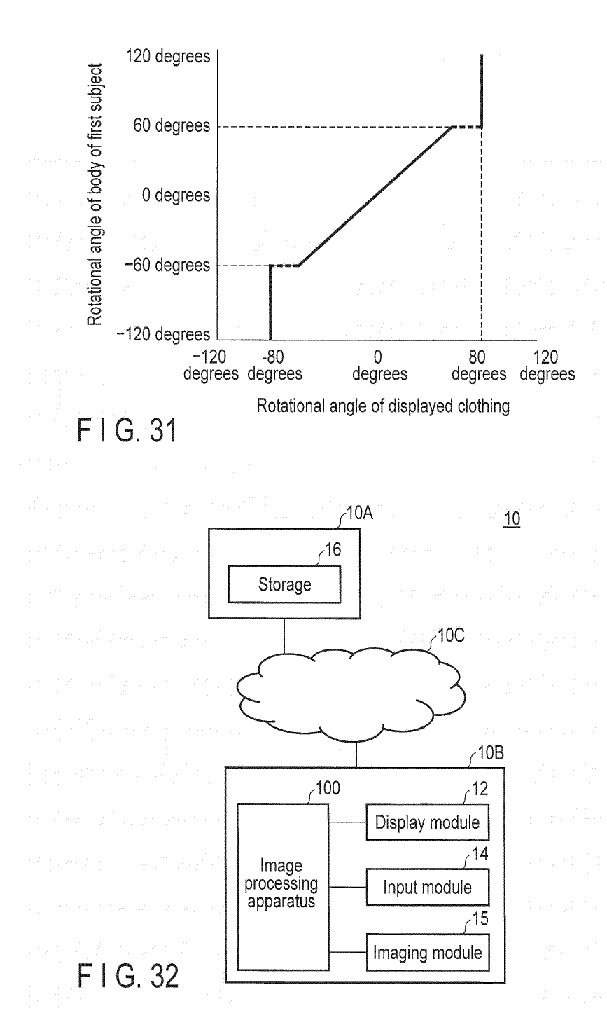

Referring now to FIG. 32, a schematic system configuration of the image processing system 10 in the embodiment will be described.

In the image processing system 10, storage device 10A and processing device 10B are connected to each other via communication line 10C, for example. Storage device 10A is provided with the aforementioned storage 16 shown in FIG. 2, and includes, for example, a personal computer. Processing device 10B includes the above-described image processing apparatus 100, display module 12, input module 14, and imaging module 15 (i.e., first imaging module 15A and second imaging module 15B) shown in FIGS. 1 and 2. In this configuration, elements similar to those shown in FIGS. 1 and 2 are denoted by corresponding reference numbers, and no detailed description will be given thereof. Communication line 10C is, for example, the Internet, and includes wired and wireless communication lines.

By incorporating the storage 16 in storage device 10A connected to processing device 10B via a communication line as shown in FIG. 32, storage device B16 can be accessed by a plurality of processing devices 10B. This enables the data of the storage 16 to be managed in a centralized manner.

Processing device 10B can be located in an arbitrary place. More specifically, processing device 10B may be located where the user can see a composite image, for example, in a store. Further, each function of processing device 10B may be installed in, for example, a portable device.

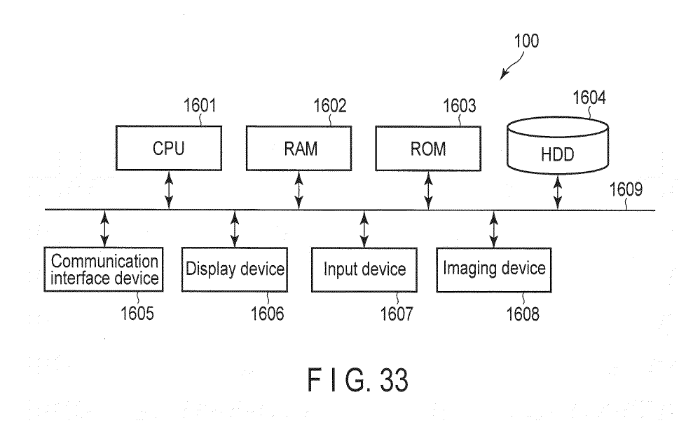

Referring last to FIG. 33, the hardware configuration of the image processing apparatus 100 according to the embodiment will be described. FIG. 33 is a block diagram showing an example of the hardware configuration of the image processing apparatus 100.

As shown in FIG. 33, in the image processing apparatus 100, a central processing unit (CPU) 1601, a random access memory (RAM) 1602, a read-only memory (ROM) 1603, a hard disk drive (HDD) 1604, a communication interface device 1605, a display device 1606, an input device 1607, an imaging device 1608, etc., are connected to each other via a bus 1609. Namely, the image processing apparatus 100 has a hardware configuration using a usual computer.

The CPU 1601 is an arithmetic device for controlling the whole image processing apparatus 100. The RAM 1602 stores data required for various types of processing executed by the CPU 1601. The ROM 1603 stores, for example, a program for realizing the various types of processing by the CPU 1601. The HDD 1604 stores data to be stored in the above-mentioned storage 16. The communication interface device 1605 is an interface for connecting the apparatus 100 to an external device or an external terminal via, for example, a communication line, and transmitting and receiving data to and from the connected external device or terminal. The display device 1606 corresponds to the above-described display module 12. The input device 1607 corresponds to the above-described input module 14. The imaging device 1608 corresponds to the above-described imaging module 15.

The program for enabling the image processing apparatus 100 of the embodiment to execute the above-mentioned various types of processing is provided, installed in the ROM 1603. Further, this program may be distributed, stored in a computer-readable storage medium. Yet further, the program may be downloaded to the image processing apparatus 100 via, for example, a network.

Various types of data stored in the above-mentioned HDD 1604, i.e., the data stored in the storage 16, may be stored in an external device (for example, a server device). In this case, the external device is connected to the CPU 1601 via, for example, the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a storage configured to store clothing images corresponding to respective rotational angles of a subject with respect to an imaging module;
an acquisition module configured to acquire a first subject image including the subject imaged by the imaging module;
a first calculator configured to calculate a first rotational angle of the subject in the first subject image;
a second calculator configured to calculate a second rotational angle different from the first rotational angle, based on the first rotational angle;
a selection module configured to select a clothing image corresponding to the second rotational angle of the clothing images; and
a generator configured to generate a composite image by superposing the clothing image upon the first subject image.

2. The image processing apparatus of claim 1, further comprising:
a third calculator configured to calculate a third rotational angle of the subject in a second subject image acquired before the first subject image by sequentially imaging the subject;
a fourth calculator configured to calculate a rotational speed of the subject, based on a difference between the first rotational angle and the third rotational angle,
wherein the second calculator is configured to calculate a reference angle that is uniquely determined from the first rotational angle and is at least not less than the first rotational angle, and calculate the second rotational angle by adding, to the reference angle, an offset value corresponding to the rotational speed.

3. The image processing apparatus of claim 1, wherein the second calculator is configured to output a predetermined second rotational angle, when the first rotational angle exceeds a predetermined angle.

4. The image processing apparatus of claim 1, wherein when a first operation mode is set, the selection module is configured to select a clothing image corresponding to the first rotational angle of the clothing images, and when a second operation mode different from the first operation mode is set, the selection module is configured to select a clothing image corresponding to the second rotational angle of the clothing images.

5. The image processing apparatus of claim 4, comprising a switching module configured to switch between the first and second operation modes in accordance with a user instruction.

6. The image processing apparatus of claim 4, wherein the generator is configured to process the clothing image to notify whether the first or second operation mode is set.

7. An image processing system comprising:
an imaging module configured to image a subject;
an image processing apparatus; and
an external device communicably connected to the image processing apparatus,
wherein
the external device includes a storage configured to store clothing images corresponding to respective rotational angles of a subject with respect to the imaging module;
the image processing apparatus includes:
an acquisition module configured to acquire a subject image including the subject imaged by the imaging module;
a first calculator configured to calculate a first rotational angle of the subject in the subject image;
a second calculator configured to calculate a second rotational angle different from the first rotational angle, based on the first rotational angle;
a selection module configured to select a clothing image corresponding to the second rotational angle of the clothing images; and
a generator configured to generate a composite image by superposing the clothing image upon the subject image.

8. A non-transitory computer-readable storage medium having stored thereon a computer program which is executable by a computer which uses a storage configured to store clothing images corresponding to respective rotational angles of a subject with respect to an imaging module, the computer program comprising instructions capable of causing the computer to execute functions of:
acquiring a subject image including the subject imaged by the imaging module;
calculating a first rotational angle of the subject in the subject image;
calculating a second rotational angle different from the first rotational angle, based on the first rotational angle;
selecting a clothing image corresponding to the second rotational angle of the clothing images; and
generating a composite image by superposing the clothing image upon the subject image.
